(19) United States
(12) Patent Application Publication
(10) Pub. No.: US 2025/0384346 A1
(43) Pub. Date: Dec. 18, 2025

(54) Generation and Processing of Reduced Dimensionality Embeddings

(71) Applicant: Google LLC, Mountain View, CA (US)

(72) Inventors: Jinsung Yoon, Sunnyvale, CA (US); Rajarishi Sukant Sinha, Pittsburgh, PA (US); Sercan Omer Arik, San Francisco, CA (US)

(21) Appl. No.: 19/238,222

(22) Filed: Jun. 13, 2025

Related U.S. Application Data
(60) Provisional application No. 63/660,448, filed on Jun. 14, 2024.

(51) Int. Cl. G06N 20/00

(52) U.S. Cl. CPC G06N 20/00

(57) ABSTRACT

Methods, systems, devices, and non-transitory computer readable media for generating reduced dimensionality embeddings are provided. The disclosed technology can include receiving high-dimensionality embeddings comprising high-dimensionality vectors comprising a first plurality of dimensions. Based on inputting the high-dimensionality embeddings into a dimensionality reduction model that is configured to reduce the dimensionality of vectors of embeddings, a plurality of low-dimensionality embeddings comprising a plurality of low-dimensionality vectors can be generated. Each of the plurality of low-dimensionality vectors can be based on the high-dimensionality vectors of the high-dimensionality embeddings and can comprise a second plurality of dimensions that is smaller than the first plurality of dimensions of the high-dimensionality vectors. The plurality of low-dimensionality embeddings can be stored.

### PRIORITY CLAIM

The present application is based on and claims priority to U.S. Provisional Application 63/660,448 having a filing date of Jun. 14, 2024, which is incorporated by reference herein.

### FIELD

The present disclosure relates generally to machine learning processes and machine-learned devices and systems. More particularly, the present disclosure relates to using a machine-learned model to reduce the size of high-dimensionality embeddings.

### BACKGROUND

Machine-learning systems may use various structures and algorithms to perform operations that provide a variety of useful services. In particular, large language models (LLMs) have been leveraged to perform operations that involve the use of large datasets. In particular, LLMs may use embeddings that provide a numerical representation of non-numerical data such as text and/or imagery. However, the size of embeddings has grown in proportion to the increasing demands that are being placed on LLMs. As a result, the effectiveness of these services and user experiences may rely on the effectiveness with which these embeddings are deployed. Accordingly, there may be different approaches to processing embeddings.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of reducing the dimensionality of embeddings. The computer-implemented method can comprise receiving, by a computing system comprising one or more processors, high-dimensionality embeddings comprising high-dimensionality vectors comprising a first plurality of dimensions. The computer-implemented method can comprise generating, by the computing system, based on inputting the high-dimensionality embeddings into a dimensionality reduction model that is configured to reduce the dimensionality of vectors of embeddings, a plurality of low-dimensionality embeddings comprising a plurality of low-dimensionality vectors. Each of the plurality of low-dimensionality vectors can be based on the high-dimensionality vectors of the high-dimensionality embeddings and can comprise a second plurality of dimensions that is smaller than the first plurality of dimensions of the high-dimensionality vectors. Furthermore, the computer-implemented method can comprise storing, by the computing system, the plurality of low-dimensionality embeddings.

Another example aspect of the present disclosure is directed to one or more tangible non-transitory computer-readable media storing computer-readable instructions that when executed by one or more processors cause the one or more processors to perform operations. The operations can comprise receiving high-dimensionality embeddings comprising high-dimensionality vectors comprising a first plurality of dimensions. The operations can comprise generating, based on inputting the high-dimensionality embeddings into a dimensionality reduction model that is configured to reduce the dimensionality of vectors of embeddings, a plurality of low-dimensionality embeddings comprising a plurality of low-dimensionality vectors. Each of the plurality of low-dimensionality vectors can be based on the high-dimensionality vectors of the high-dimensionality embeddings and can comprise a second plurality of dimensions that is smaller than the first plurality of dimensions of the high-dimensionality vectors. Furthermore, the operations can comprise storing the plurality of low-dimensionality embeddings.

Another example aspect of the present disclosure is directed to a computing system comprising: one or more processors; one or more non-transitory computer-readable media storing instructions that when executed by the one or more processors cause the one or more processors to perform operations. The operations can comprise receiving high-dimensionality embeddings comprising high-dimensionality vectors comprising a first plurality of dimensions. The operations can comprise generating, based on inputting the high-dimensionality embeddings into a dimensionality reduction model that is configured to reduce the dimensionality of vectors of embeddings, a plurality of low-dimensionality embeddings comprising a plurality of low-dimensionality vectors. Each of the plurality of low-dimensionality vectors can be based on the high-dimensionality vectors of the high-dimensionality embeddings and can comprise a second plurality of dimensions that is smaller than the first plurality of dimensions of the high-dimensionality vectors. Furthermore, the operations can comprise storing the plurality of low-dimensionality embeddings.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram depicting an example computing environment including a machine-learning system configured to reduce the dimensionality of embeddings according to example embodiments of the present disclosure;

FIG. 2 is an example of loss functions including top-k loss and pairwise similarity loss that can be used in training a dimensionality reduction model according to example embodiments of the present disclosure;

FIG. 3 is a block diagram depicting an example of supervised and unsupervised training of dimensionality reduction models according to example embodiments of the present disclosure;

FIG. 4 depicts a flow chart diagram of an example method to reduce the dimensionality of embeddings according to example embodiments of the present disclosure;

FIG. 5 depicts a flow chart diagram of an example method to train a dimensionality reduction model that is configured to reduce the dimensionality of embeddings according to example embodiments of the present disclosure;

FIG. 6 depicts a flow chart diagram of an example method to train a dimensionality reduction model that is configured to reduce the dimensionality of embeddings according to example embodiments of the present disclosure;

FIG. 7 is a block diagram of an example processing flow for using machine-learned model(s) to process input(s) to generate output(s) according to example embodiments of the present disclosure;

FIG. 8 is a block diagram of an example sequence processing model according to example embodiments of the present disclosure;

FIG. 9 is a block diagram of an example technique for populating an example input sequence for processing by a sequence processing model according to example embodiments of the present disclosure;

FIG. 10 is a block diagram of an example model development platform according to example embodiments of the present disclosure;

FIG. 11 is a block diagram of an example training workflow for training a machine-learned model according to example embodiments of the present disclosure;

FIG. 12 is a block diagram of an inference system for operating one or more machine-learned model(s) to perform inference according to example embodiments of the present disclosure;

FIG. 13 is a block diagram of an example networked computing system according to example embodiments of the present disclosure;

FIG. 14 is a block diagram of an example computing device according to example embodiments of the present disclosure; and

FIG. 15 is a block diagram of an example computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

In general, the present disclosure is directed to generating a low-dimensionality embedding based on a given embedding that has a higher dimensionality than the low-dimensionality embedding. In particular, the disclosed technology can use one or more machine-learned models (e.g., a dimensionality reduction model) that is configured and/or trained to generate a plurality of low-dimensionality embeddings based on a given high-dimensionality embedding. Each of the plurality of low-dimensionality embeddings can be based on the high-dimensionality embedding and can be selected for use by a large language model (LLM). Further, the disclosed technology can train the dimensionality reduction model using various techniques including a pairwise loss function, a top-k loss function, and/or a ranking loss function.

In accordance with example embodiments of the disclosed technology, computing systems and methods are provided to automatically receive high-dimensionality embeddings. The high-dimensionality embeddings can comprise high-dimensionality vectors (e.g., vectors with more than 1024 dimensions) that have a first plurality of dimensions. The disclosed dimensionality reduction model can be configured to generate a plurality of low-dimensionality embeddings comprising a plurality of low-dimensionality vectors. Each of the plurality of low-dimensionality vectors can be based on the high-dimensionality vectors of the high-dimensionality embeddings and can comprise a second plurality of dimensions that is smaller than the first plurality of dimensions of the high-dimensionality vectors. Further, each of the plurality of low-dimensionality embeddings can be a different size (e.g., have vectors with a different number of dimensions). For example, if high-dimensionality embedding has a high-dimensionality vector that has 1024 dimensions, the dimensionality reduction model can generate three low-dimensionality embeddings, including a first low-dimensionality embedding with a first vector that has 512 dimensions, a second low-dimensionality embedding with a second vector that has 256 dimensions, and a third low-dimensionality embedding with a third vector that has 128 dimensions. The disclosed technology can store the plurality of low-dimensionality embeddings so that the low-dimensionality embeddings can be accessed for later use.

Embeddings from Large Language Models (LLMs) can be used as components in various applications which can include information retrieval, natural language processing, and/or image recognition. While high-dimensionality embeddings can demonstrate superior performance as they contain more salient information, their practical application can be hindered by elevated computational latency and the associated higher cost. To address this challenge, the disclosed technology can implement a dimensionality reduction model. The dimensionality reduction model can facilitate substantial dimensionality reduction while maintaining comparable performance levels, thereby achieving a significant enhancement in computational efficiency and cost-effectiveness. The disclosed framework can operate by directly modifying the embeddings from pre-trained LLMs. Further, the disclosed technology can be integrated into various architectures (e.g., LLM architectures).

According to example aspects of the present disclosure, a computing system (e.g., a machine-learning computing system such as the machine-learning computing system 110) is provided that can receive high-dimensionality embeddings that can comprise high-dimensionality vectors that can comprise a first plurality of dimensions. For example, the computing system can receive high-dimensionality embeddings that were generated for use by an LLM. The high-dimensionality embeddings can be received via a network or received from a locally accessible device. Further, the high dimensionality embeddings can comprise representations of information and/or data comprising images, video segments, text segments, audio-video segments, and/or audio segments, each encoded into a vector space with a substantial number of dimensions.

The computing system can generate a plurality of low-dimensionality embeddings that can comprise a plurality of low-dimensionality vectors. The plurality of low-dimensionality embeddings can be generated based on inputting the high-dimensionality embeddings into a dimensionality reduction model that is configured to reduce the dimensionality of vectors of embeddings. Each of the plurality of low-dimensionality vectors can be based on the high-dimensionality vectors of the high-dimensionality embeddings. Further, each of the plurality of low-dimensionality embeddings can comprise a second plurality of dimensions that is smaller than the first plurality of dimensions of the high-dimensionality vectors (e.g., if the high-dimensionality embedding is 1024 dimensions, each of the plurality of low-dimensionality embeddings can have fewer than 1024 dimensions).

The plurality of low-dimensionality embeddings can comprise two or more low-dimensionality embeddings that have a lower dimensionality than the high-dimensionality embeddings. Further, the plurality of low-dimensionality embeddings can have a plurality of different vectors that have a plurality of different dimensions. For example, the plurality of low-dimensionality embeddings can have different dimensions from the other plurality of low-dimensionality embeddings (e.g., a first low-dimensionality embedding with 768 dimensions, a second low-dimensionality embedding with 512 dimensions, and a third low-dimensionality embedding with 256 dimensions).

The computing system can store the plurality of low-dimensionality embeddings. Further, the computing system can store the plurality of low-dimensionality embeddings in various suitable storage architectures. For example, the plurality of low-dimensionality embeddings can be stored in a remote computing device that can be accessed by other computing devices via a network (e.g., a LAN or the Internet). Such a remote storage location can facilitate broad accessibility and/or collaborative use of the embeddings across distributed systems. Additionally, the computing system can store the plurality of low-dimensionality embeddings on a local storage device, which can include a solid-state drive (SSD) or a hard disk drive (HDD), to enable rapid access by the computing system itself. The storage mechanism can be configured to support efficient retrieval operations, including indexing structures that allow for quick identification and loading of specific low-dimensionality embeddings based on contextual queries. Furthermore, the storage operations may include compression techniques to further reduce the physical storage footprint of the embeddings, enhancing overall system efficiency and reducing storage costs. The storage configurations can be optimized for read-heavy workloads including those in inference operations in which the embeddings are frequently accessed but less frequently modified.

The computing system can receive high-dimensionality training embeddings that can comprise high-dimensionality training vectors that can comprise a third plurality of dimensions. For example, the high dimensionality training embeddings can comprise representations of various forms of information and/or data which can include images, video segments, text segments, audio-video segments, and/or audio segments, each encoded into a vector space with a substantial number of dimensions. These training embeddings can serve as input for the dimensionality reduction model during its training phase. The third plurality of dimensions can indicate the original size (e.g., large size) of these training vectors before any reduction operations are performed.

The computing system can generate low-dimensionality training embeddings. Generation of the low-dimensionality training embeddings can be based on inputting the high-dimensionality training embeddings into the dimensionality reduction model. The low-dimensionality training embeddings can comprise low-dimensionality training vectors that can comprise a fourth plurality of dimensions that is smaller than the third plurality of dimensions of the high-dimensionality training embeddings. Generating the low-dimensionality training embeddings can comprise training the dimensionality reduction model to learn how to effectively compress the high-dimensionality input without significant loss of information. For example, the high-dimensionality training embeddings may be vectors of 1024 dimensions, while the resulting low-dimensionality training embeddings can have dimensions of 512, 256, or 128. This reduction in dimensionality can result in more efficient downstream processing, which can reduce the computational burden and storage requirements.

The computing system can process each high-dimensionality training vector and project it into a lower-dimensional space. This projection of each high-dimensionality training vector into a lower-dimensional space can comprise the performance of operations (e.g., various mathematical transformations implemented by the dimensionality reduction model in which the mathematical transformations can comprise linear transformations and/or non-linear activations) and can be determined based on the architecture of the dimensionality reduction model (e.g., a multilayer perceptron). The dimensionality reduction model can be configured and/or trained to preserve the semantic and/or structural relationships present in the original high-dimensionality space within the compressed low-dimensionality representation. For instance, if two high-dimensionality training embeddings are semantically similar, their corresponding low-dimensionality training embeddings should also exhibit a high degree of similarity. This preservation of relationships can be evaluated in subsequent steps of the training process, where the similarity between the original and reduced embeddings is determined, and a loss is determined to guide the modification of the dimensionality reduction model's parameters. This iterative process can allow the dimensionality reduction model to progressively enhance its ability to generate compact yet informative low-dimensionality training embeddings.

The computing system can determine an amount of similarity between the high-dimensionality training embeddings and the low-dimensionality training embeddings. The computing system can retrieve a specific high-dimensionality training embedding from a stored collection. Concurrently, the computing system can retrieve the corresponding low-dimensionality training embedding that was generated from that high-dimensionality training embedding. For example, if the high-dimensionality training embedding represents a particular document and its low-dimensionality counterpart is the reduced representation of the same document, the system would access both to perform the comparison. Determining the amount of similarity can comprise normalizing the vectors to unit length prior to determining the dot product, which can simplify the cosine similarity determination (e.g., calculation of the cosine similarity).

In some embodiments, the computing system can perform a comparison of the high-dimensionality training vectors to the low-dimensionality training vectors. This comparison can comprise a projection of the high-dimensionality vector into the lower-dimensional space prior to the similarity determination, and/or the comparison can comprise techniques that compare features across different dimensionalities. The objective is to quantify how much of the original information or semantic meaning is retained after the dimensionality reduction. For example, if two high-dimensionality training embeddings were originally very similar in their semantic content (e.g., two documents discussing the same topic), their corresponding low-dimensionality training embeddings can also have a high degree of similarity. Further, if two high-dimensionality training embeddings are dissimilar, their low-dimensionality counterparts can maintain that dissimilarity.

The determination of similarity can be performed for a large dataset of training embeddings. This enables the computing system to obtain a comprehensive understanding of the dimensionality reduction model's performance across various data types and contexts. The aggregate similarity scores can then be used to determine a loss value, which can serve as a feedback signal for optimizing the dimensionality reduction model. A higher similarity score can indicate a more effective dimensionality reduction, meaning that the low-dimensionality embeddings largely preserve the characteristics of their high-dimensionality counterparts.

The computing system can determine a loss based on the amount of similarity between the high-dimensionality training embeddings and the low-dimensionality training embeddings. The loss can indicate the extent to which the dimensionality reduction model preserves significant characteristics and/or relationships of the high-dimensionality data when transforming it into a lower-dimensional representation. A smaller loss value can indicate that the low-dimensionality training embeddings retain a higher degree of fidelity and/or similarity to their high-dimensionality counterparts.

Various methods can be used to determine the loss. For example, the computing system can determine a top-k similarity loss based on the amount of similarity between the high-dimensionality training embeddings and the low-dimensionality training embeddings. Top-k similarity loss can evaluate the extent to which neighborhood relationships are preserved. For each high-dimensionality training embedding, a set of its ‘k’ nearest neighbors in the high-dimensional space can be identified. The top-k similarity loss can then be used to determine how many of these original neighbors are still within the ‘k’ nearest neighbors of the corresponding low-dimensionality training embedding in the reduced space. A lower top-k similarity loss indicates that the local structural integrity of the embedding space is largely maintained after dimensionality reduction.

In some embodiments, the computing system can determine a pairwise loss based on an amount of similarity between the high-dimensionality training embeddings and the low-dimensionality training embeddings. Pairwise loss functions can be configured to focus on preserving the relative distances and/or similarities between all pairs of embeddings. For example, if two high-dimensionality training embeddings have a certain similarity score, their corresponding low-dimensionality training embeddings should ideally exhibit a proportional similarity score. The pairwise loss quantifies the deviation from this proportionality across numerous pairs of embeddings. By minimizing this loss, the dimensionality reduction model can learn to maintain a consistent mapping of global relationships, ensuring that the overall structure of the embedding space is preserved.

Furthermore, the determination of the loss can comprise comparing the high-dimensionality training vectors to the low-dimensionality training vectors. This comparison can comprise projecting the high-dimensionality training vectors into the low-dimensional space for a one-to-one comparison, or it can comprise more complex transformations that align the feature spaces. The objective is to quantify the discrepancy and/or error introduced by the dimensionality reduction process. For example, if the dimensionality reduction model processes a high-dimensionality vector to generate a low-dimensionality vector, determination of the loss can be used to assess how much information was lost and/or distorted during this transformation. The specific operations (e.g., mathematical operations) used for the loss function can vary depending on the chosen similarity metric and/or the target characteristics (e.g., a target number of dimensions) of the low-dimensionality embeddings. The loss can be positively correlated with the amount of similarity between the high-dimensionality training embeddings and the low-dimensionality training embeddings at a plurality of different fourth pluralities of dimensions that are smaller than the third plurality of dimensions of the high-dimensionality training embeddings. As the similarity between the original and reduced embeddings increases, the loss value decreases, thereby reinforcing the optimization goal.

The computing system can modify, based on the loss, a weighting of parameters of the dimensionality reduction model. The weighting of the parameters can be modified to minimize the loss. The weighting of the parameters can be modified to minimize the loss. The parameters of the dimensionality reduction model can comprise internal variables that define its specific transformation behavior. For example, in a multilayer perceptron (MLP), these parameters can include the weights connecting different layers and the bias terms applied at each neuron. These parameters can influence how an input high-dimensionality vector is projected into a lower-dimensional space.

The modification of these parameters can be performed through an optimization algorithm, which can include gradient descent and/or its variants (e.g., stochastic gradient descent, Adam, or RMSprop). When a loss is determined, indicating a discrepancy and/or error in the dimensionality reduction, the optimization algorithm can be used to calculate the gradient of this loss with respect to each parameter. The gradient indicates the direction and magnitude by which each parameter should be adjusted to reduce the loss. For example, if increasing a particular weight slightly leads to a reduction in loss, the algorithm can adjust that weight in the increasing direction.

Modifying the weighting of the parameters can comprise iteratively adjusting the internal configuration of the dimensionality reduction model until the determined loss reaches a minimum and/or a sufficiently low value. This minimization can indicate that the dimensionality reduction model has learned an effective mapping that preserves the critical information from the high-dimensionality embeddings while achieving the targeted reduction in dimensionality. The training process can comprise multiple iterations, or “epochs,” in which for each iteration, a batch of high-dimensionality training embeddings is processed, their low-dimensionality counterparts are generated, a loss is determined, and the parameters are updated. This iterative feedback loop allows the dimensionality reduction model to converge towards an optimal state in which the low-dimensionality embeddings accurately reflect the underlying semantics and relationships of the original high-dimensionality data. This approach can be applied to various types of dimensionality reduction models, including those that are trained using unsupervised learning operations (e.g., determining a top-k similarity loss and/or a pairwise similarity loss by comparing document embeddings) or supervised learning (e.g., determining a ranking loss by comparing corpus embeddings to other corpus embeddings, query embeddings to other query embeddings, or query-corpus pairs to other query-corpus pairs).

In some embodiments, determining an amount of similarity between the high-dimensionality training embeddings and the low-dimensionality training embeddings can comprise determining a cosine similarity between the high-dimensionality embeddings and the low-dimensionality embeddings. Cosine similarity can determine the cosine of the angle between two non-zero vectors in a multi-dimensional space. A value closer to 1 can indicate higher similarity, a value closer to −1 can indicate higher dissimilarity, and a value closer to 0 can indicate orthogonality or independence. For example, the computing system can determine a cosine similarity between the high-dimensionality training corpus embeddings and the low-dimensionality training corpus embeddings. This comparison evaluates the extent to which the semantic content of original corpus documents is maintained in their reduced-dimensionality representations. Further, the computing system can determine a cosine similarity between the high-dimensionality training query embeddings and the low-dimensionality training query embeddings, assessing the fidelity of query representations after dimensionality reduction. This allows for a quantitative assessment of the extent to which the reduced-dimensionality training outputs preserve the directional relationships of their corresponding high-dimensionality training inputs in the embedding space.

The determination of similarity can extend to various components of the training input and output. For example, if the training input comprises high-dimensionality query-corpus pairs that indicate relevance, the similarity determination can also implicitly assess the extent to which this relevance is maintained in the low-dimensionality output. The process can comprise retrieving a high-dimensionality training embedding (e.g., a high-dimensionality training corpus embedding or a high-dimensionality training query embedding) and its corresponding low-dimensionality training embedding from the training output. The cosine similarity determination can then be performed between these pairs of vectors. Normalizing the vectors to unit length prior to determining the dot product can be performed to ensure that the magnitude of the vectors does not influence the similarity score, focusing on the orientation of the vectors in the embedding space.

In some implementations, the system can perform this similarity determination across large batches of training data, accumulating a comprehensive understanding of the dimensionality reduction model's performance. The objective is to quantify how much of the original information and/or semantic meaning is retained after the dimensionality reduction, which impacts the utility of the low-dimensionality embeddings in downstream applications. For example, in information retrieval tasks, based on a query the computing system can generate a low-dimensionality query embedding that accurately reflects the original query's intent and accurately represents the content of the document that is being queried. Maintaining high cosine similarity between the original and reduced forms of these embeddings can indicate that the dimensionality reduction process is successful in preserving these critical aspects. This continuous evaluation of similarity can provide a basis for the subsequent determination of a loss value, which can guide the iterative adjustment of the dimensionality reduction model's parameters to further minimize information loss and enhance representational fidelity.

In some embodiments, determining a loss based on the amount of similarity between the high-dimensionality training embeddings and the low-dimensionality training embeddings, a loss can comprise determining a top-k similarity loss based on the amount of similarity between the high-dimensionality training embeddings and the low-dimensionality training embeddings. This top-k similarity loss is based on the amount of similarity observed between the high-dimensionality training embeddings and the corresponding low-dimensionality training embeddings. This particular loss function can assess how effectively the dimensionality reduction process preserves the local neighborhood structure of the embeddings.

For each high-dimensionality training embedding, a set of its ‘k’ most similar neighbors within the high-dimensional space can be identified. The top-k similarity loss then quantifies the extent to which these original neighbors are retained within the ‘k’ most similar neighbors of the corresponding low-dimensionality training embedding in the reduced-dimensional space. A reduced top-k similarity loss can indicate that the local structural integrity of the embedding space is largely maintained following the dimensionality reduction operation.

In some embodiments, determining a loss based on the amount of similarity between the high-dimensionality training embeddings and the low-dimensionality training embeddings, can comprise determining a pairwise loss based on the amount of similarity between the high-dimensionality training embeddings and the low-dimensionality training embeddings. A pairwise loss can be determined based on an amount of similarity between the high-dimensionality training embeddings and the corresponding low-dimensionality training embeddings. The pairwise loss function can assess how effectively the dimensionality reduction process preserves the relative distances and/or similarities between all pairs of embeddings.

Specifically, the pairwise loss, which can be denoted as Lpair, is configured to ensure that if two high-dimensionality training embeddings have a certain similarity score (e.g., a high cosine similarity indicating they are semantically close), their corresponding low-dimensionality training embeddings should ideally exhibit a proportional or similar score. The pairwise loss quantifies the deviation from this targeted proportionality across numerous pairs of embeddings within the training dataset. By minimizing this pairwise loss, the dimensionality reduction model can learn to maintain a consistent mapping of global relationships from the high-dimensional space to the lower-dimensional space. This can result in the overall structure and relationships within the embedding space being largely preserved after dimensionality reduction. For example, if a cluster of high-dimensionality document embeddings represents documents on a specific topic, minimizing pairwise loss can be used to ensure that their low-dimensionality counterparts also form a coherent cluster, maintaining their relative proximity.

In some embodiments, determining a loss based on the amount of similarity between the high-dimensionality training embeddings and the low-dimensionality training embeddings, a loss can comprise comparing the high-dimensionality training vectors to the low-dimensionality training vectors. Further, determining the amount of similarity can comprise determining the amount of similarity based on the comparison of the high-dimensionality training vectors to the low-dimensionality training vectors. This determination of the loss can comprise comparing the high-dimensionality training vectors to the low-dimensionality training vectors. Such a comparison can entail projecting the high-dimensionality training vectors into the low-dimensional space for a one-to-one correspondence or can comprise more intricate transformations that align the feature spaces. The objective is to quantify the discrepancy and/or error introduced by the dimensionality reduction process. For example, if the dimensionality reduction model processes a high-dimensionality vector to generate a low-dimensionality vector, the loss determination can be used to assess an amount of information that was lost and/or corrupted during this transformation. The loss function can vary depending on the chosen similarity metric and/or the targeted characteristics of the low-dimensionality embeddings.

Furthermore, the determination of the amount of similarity can be based on the comparison of the high-dimensionality training vectors to the low-dimensionality training vectors. This means that the similarity score, which quantifies the resemblance between the original and reduced representations, can be derived from the evaluation of these vectors. For example, if the comparison comprises determining a cosine similarity between a high-dimensionality vector and its corresponding low-dimensionality vector, the resulting cosine similarity score can indicate the amount of similarity.

In some embodiments, the loss can be positively correlated with the amount of similarity between the high-dimensionality training embeddings and the low-dimensionality training embeddings at a plurality of different fourth pluralities of dimensions that are smaller than the third plurality of dimensions of the high-dimensionality training embeddings. This positive correlation can indicate that as the similarity between the original and reduced embeddings increases across various reduced dimensionalities, the loss value decreases, thereby reinforcing the optimization goal for the dimensionality reduction model. This iterative process of determining similarity, determining loss, and adjusting parameters can enable the dimensionality reduction model to progressively enhance its ability to generate compact yet informative low-dimensionality embeddings across a spectrum of possible reduced dimensions.

The computing system can receive training input that can comprise high-dimensionality training corpus embeddings, high-dimensionality training query embeddings, and/or high-dimensionality query-corpus pairs. The training input received by the computing system can include various forms of high-dimensionality embeddings designed to facilitate the comprehensive training of the dimensionality reduction model. This input can specifically comprise high-dimensionality training corpus embeddings, high-dimensionality training query embeddings, or high-dimensionality query-corpus pairs. High-dimensionality training corpus embeddings can represent large collections of documents and/or other textual content, encoded into a high-dimensional vector space that captures rich semantic information. For example, a document can be represented by a vector with thousands of dimensions, where each dimension contributes to encoding the document's content and context. Similarly, high-dimensionality training query embeddings can represent search queries, questions, and/or other forms of informational requests, also encoded into a high-dimensional vector space. These query embeddings can be structured to capture the semantic intent of the query, allowing for effective matching against corpus embeddings. Furthermore, high-dimensionality query-corpus pairs can provide explicit relevance judgments, linking specific queries to relevant documents and/or text segments. These pairs can serve as ground truth labels, indicating which documents are pertinent to particular queries.

The computing system can generate, based on inputting the training input into the dimensionality reduction model, training output that can comprise low-dimensionality training corpus embeddings and/or low-dimensionality training query embeddings. A dimensionality of the low-dimensionality training corpus embedding can be lower than a dimensionality of the high-dimensionality training corpus embedding. Further, a dimensionality of the low-dimensionality training query embedding can be lower than a dimensionality of the high-dimensionality training query embedding. This training output can comprise low-dimensionality training corpus embeddings and low-dimensionality training query embeddings. The dimensionality reduction model can be configured and/or trained to generate training output that occupies a significantly smaller vector space while aiming to preserve the semantic integrity of their high-dimensional counterparts. For example, a high-dimensionality corpus embedding that originally had 1024 dimensions could be transformed into a low-dimensionality corpus embedding with 256 dimensions.

Generating the low-dimensionality representations can comprise the dimensionality reduction model applying its learned transformations to the high-dimensionality training input. The dimensionality reduction model can be configured and/or trained to determine that the compressed representations retain the significant information and/or semantic relationships present in their high-dimensionality counterparts, even with a reduced number of dimensions. The efficacy of this reduction can be evaluated in subsequent steps of the training process to ensure that the compression does not lead to a significant loss of utility and/or accuracy in downstream applications. This iterative training process can continually refine the dimensionality reduction model to generate compact yet highly informative embeddings.

The computing system can determine an amount of similarity between the training input and the training output. This determination can be used to assess the effectiveness with which the dimensionality reduction model has been configured and/or trained to compress high-dimensionality data while preserving relevant information. One metric for determining this similarity is cosine similarity. Determining cosine similarity can comprise determining the cosine of the angle between two non-zero vectors in a multi-dimensional space. A value closer to 1 can indicate higher similarity, a value closer to −1 can indicate higher dissimilarity, and a value near 0 can suggest orthogonality or independence. For example, the computing system can determine a cosine similarity between the high-dimensionality training corpus embeddings and the low-dimensionality training corpus embeddings. This comparison evaluates the extent to which the semantic content of original corpus documents is maintained in their reduced-dimensionality representations.

Further, the computing system can determine a cosine similarity between the high-dimensionality training query embeddings and the low-dimensionality training query embeddings, assessing the fidelity of query representations after dimensionality reduction. This allows for a quantitative assessment of the extent to which the reduced-dimensionality training outputs preserve the directional relationships of their corresponding high-dimensionality training inputs in the embedding space. The determination of similarity can extend to various components of the training input and output. For example, if the training input comprises high-dimensionality query-corpus pairs that indicate relevance, the similarity determination can also implicitly assess the extent to which this relevance is maintained in the low-dimensionality output. The process can comprise retrieving a high-dimensionality training embedding (e.g., a high-dimensionality training corpus embedding or a high-dimensionality training query embedding) and its corresponding low-dimensionality training embedding from the training output. The cosine similarity determination can then be performed between these pairs of vectors. Normalizing the vectors to unit length prior to determining the dot product can be performed to ensure that the magnitude of the vectors does not influence the similarity score, focusing on the orientation of the vectors in the embedding space.

The computing system can determine a loss based on the amount of similarity between the training input and the training output. The loss can indicate how effectively the dimensionality reduction model preserves the essential characteristics, significant characteristics, and/or significant relationships of the high-dimensionality data when transforming it into a lower-dimensional representation. A smaller loss value can indicate that the low-dimensionality training embeddings retain a higher degree of fidelity to their high-dimensionality counterparts, which is a primary objective of the dimensionality reduction process. Various techniques can be employed to determine this loss. For example, the computing system can determine a ranking loss based on the amount of similarity between the high-dimensionality training corpus embeddings and the low-dimensionality training corpus embeddings. A ranking loss can be relevant for applications that comprise information retrieval, in which the objective is to order documents and/or results based on their relevance to a query. Determining the ranking loss can also comprise comparing corpus embeddings to other corpus embeddings, comparing query embeddings to other query embeddings, and/or comparing query-corpus pairs to other query-corpus pairs.

When comparing corpus embeddings to other corpus embeddings, the ranking loss can assess the extent to which the relative relevance of various documents within a collection is maintained after dimensionality reduction. Further, when comparing query embeddings to other query embeddings, the loss can ensure that the relative similarity of different queries remains consistent in the reduced space. The comparison of query-corpus pairs can evaluate the preservation of relevance relationships between queries and documents. For example, if a specific document is highly relevant to a particular query in the high-dimensional space, the ranking loss can ensure that the reduced-dimensionality versions of that query and document still exhibit a strong relevance, leading to the document being ranked highly for that query.

The loss can be positively correlated with an amount of similarity between the input training data and the output training data at a plurality of different dimensionalities in which the dimensionality of the training output is smaller than the dimensionality of the input training data. This positive correlation can indicate that as the similarity between the original and reduced embeddings increases across various reduced dimensionalities, the loss value decreases, thereby reinforcing the optimization goal for the dimensionality reduction model.

The computing system can modify, based on the loss, a weighting of parameters of the dimensionality reduction model. The weighting of the parameters can be modified to minimize the loss. The weighting of the parameters can be modified to minimize the loss. This modification process is central to the training of the dimensionality reduction model, enabling it to progressively learn and improve its ability to transform high-dimensionality embeddings into low-dimensionality representations with minimal information loss.

The parameters of the dimensionality reduction model are internal variables that define its specific transformation behavior. For example, in a multilayer perceptron (MLP), these parameters can include the weights connecting different layers and the bias terms applied at each neuron. These parameters influence how an input high-dimensionality vector is projected into a lower-dimensional space. The modification of these parameters can be performed through an optimization algorithm, which can include gradient descent and/or its variants (e.g., stochastic gradient descent, Adam, RMSprop). When a loss is determined, indicating a discrepancy and/or error in the dimensionality reduction, the optimization algorithm can be used to calculate the gradient of this loss with respect to each parameter. The gradient indicates the direction and magnitude by which each parameter may be adjusted to reduce the loss. For example, if increasing a particular weight slightly leads to a reduction in loss, the algorithm can adjust that weight in the increasing direction.

The computing system can modify the weighting of the parameters in order to iteratively adjust the internal configuration of the dimensionality reduction model until the determined loss reaches a minimum and/or a sufficiently low value. This minimization can indicate that the dimensionality reduction model has learned an effective mapping that preserves the critical information from the high-dimensionality embeddings while achieving the targeted reduction in dimensionality. The training process can comprise multiple iterations, or “epochs,” where in each iteration, a batch of high-dimensionality training embeddings is processed, their low-dimensionality counterparts can be generated, a loss is determined, and the parameters can be updated. This iterative feedback loop allows the dimensionality reduction model to converge towards an optimal state where the low-dimensionality embeddings accurately reflect the underlying semantics and relationships of the original high-dimensionality data. This approach can be applied to various types of dimensionality reduction models, including those that can be trained using unsupervised learning operations (e.g., determining a top-k similarity loss or a pairwise similarity loss by comparing document embeddings) or supervised learning (e.g., determining a ranking loss by comparing corpus embeddings to other corpus embeddings, query embeddings to other query embeddings, or query-corpus pairs to other query-corpus pairs).

In some embodiments, determining an amount of similarity between the training input and the training output can comprise determining a cosine similarity between the high-dimensionality training corpus embeddings and the low-dimensionality training corpus embeddings. Further, determining an amount of similarity between the training input and the training output can comprise determining a cosine similarity between the high-dimensionality training query embeddings and the low-dimensionality training query embeddings. Determining cosine similarity can comprise determining the cosine of the angle between two non-zero vectors in a multi-dimensional space. A value closer to 1 can indicate higher similarity, a value closer to −1 can indicate higher dissimilarity, and a value near 0 can suggest orthogonality or independence. For example, the computing system can determine a cosine similarity between the high-dimensionality training corpus embeddings and the low-dimensionality training corpus embeddings. This comparison can evaluate the extent to which the semantic content of original corpus documents is maintained in their reduced-dimensionality representations.

Further, the computing system can determine a cosine similarity between the high-dimensionality training query embeddings and the low-dimensionality training query embeddings, assessing the fidelity of query representations after dimensionality reduction. This allows for a quantitative assessment of the extent to which the reduced-dimensionality training outputs preserve the directional relationships of their corresponding high-dimensionality training inputs in the embedding space.

In some embodiments, determining a loss based on the amount of similarity between the training input and the training output can comprise determining a ranking loss based on the amount of similarity between the high-dimensionality training corpus embeddings and the low-dimensionality training corpus embeddings. Further, determining a loss based on the amount of similarity between the training input and the training output can comprise determining the ranking loss based on the amount of similarity between the high-dimensionality training query embeddings and the low-dimensionality training query embeddings.

Determining the ranking loss can comprise comparing corpus embeddings to other corpus embeddings, comparing query embeddings to other query embeddings, and/or comparing query-corpus pairs to other query-corpus pairs. When comparing corpus embeddings to other corpus embeddings, the ranking loss can assess the extent to which the relative relevance of various documents within a collection is maintained after dimensionality reduction. When comparing query embeddings to other query embeddings, the computing system can monitor the loss to determine that the relative similarity of different queries remains consistent in the reduced space.

The computing system can continue to modify, based on the determined loss, a weighting of parameters of the dimensionality reduction model. The parameters of the dimensionality reduction model, which can include the weights and biases in a neural network, can determine how the high-dimensionality data is transformed into its lower-dimensional representation. To achieve this minimization, the computing system can employ optimization algorithms, which can include gradient descent (e.g., stochastic gradient descent, Adam, RMSprop). The optimization algorithms can be used to determine the gradient of the loss function with respect to each parameter. The gradient indicates the direction and magnitude in which each parameter should be adjusted to reduce the loss. For example, if a small increase in a particular weight contributes to a decrease in the loss, the optimization algorithm will adjust that weight in the increasing direction. This iterative process allows the dimensionality reduction model to progressively learn and refine its internal configuration, enabling it to map high-dimensionality embeddings to low-dimensionality embeddings more effectively and with less information loss.

This iterative modification process can be repeated over numerous training iterations or “epochs.” In each iteration, the computing system processes a batch of high-dimensionality training embeddings, generates their low-dimensionality counterparts, determines a loss based on their similarity, and then updates the model's parameters. This continuous feedback loop ensures that the dimensionality reduction model converges towards an optimal state where the low-dimensionality embeddings accurately reflect the underlying semantics and relationships of the original high-dimensionality data. The optimization of these parameters can be used to achieve a balance between dimensionality reduction and representational fidelity, ensuring that the efficiency gains do not compromise the utility of the embeddings in downstream applications. This approach can be applied when the dimensionality reduction model is trained using unsupervised learning operations (e.g., determining a top-k similarity loss or a pairwise similarity loss by comparing document embeddings) or supervised learning (e.g., determining a ranking loss by comparing corpus embeddings to other corpus embeddings, query embeddings to other query embeddings, or query-corpus pairs to other query-corpus pairs).

In some embodiments, the loss can be positively correlated with an amount of similarity between the input training data and the output training data at a plurality of different dimensionalities in which the dimensionality of the training output is smaller than the dimensionality of the input training data. This positive correlation can indicate that as the similarity between the original and reduced embeddings increases across various reduced dimensionalities, the loss value decreases, thereby reinforcing the optimization goal for the dimensionality reduction model. This iterative process of determining similarity, determining loss, and/or adjusting parameters can enable the dimensionality reduction model to progressively enhance its ability to generate compact yet informative low-dimensionality embeddings across a spectrum of possible reduced dimensions.

The computing system can receive a plurality of high-dimensionality training embeddings comprising a plurality of high-dimensionality training vectors comprising a fifth plurality of dimensions of different sizes. For example, the plurality of high-dimensionality training embeddings can include high-dimensionality vectors with 1024 dimensions, others with 512 dimensions, and still others with 256 dimensions. This variability in input dimensionality during training can be used to enable the dimensionality reduction model to generalize more effectively to different high-dimensionality input sizes that it can encounter during inference. Further, the different sizes of the training embeddings can enable the model to learn a more flexible and robust dimensionality reduction mapping that is not confined to a single fixed input dimensionality.

The computing system can generate, based on inputting the high-dimensionality training embeddings into the dimensionality reduction model, a plurality of adapted dimensionality training embeddings corresponding to the plurality of high-dimensionality training embeddings and comprising a plurality of adapted dimensionality training vectors that can be equal in size to each of the plurality of high-dimensionality training vectors respectively. For example, if a high-dimensionality training embedding with 512 dimensions is input, the model can generate an adapted dimensionality training embedding that also has 512 dimensions. The purpose of this adaptation, even without explicit dimensionality reduction, can be to refine and/or re-encode the embedding in a way that is optimized for subsequent processing and/or comparison within the model's framework. This ensures that the model learns to handle embeddings of various sizes consistently, allowing for comparisons and/or computations between original and adapted forms regardless of their absolute dimensionality, as long as their dimensions can be matched for comparison.

The computing system can determine an amount of similarity between the high-dimensionality training embeddings and the adapted dimensionality training embeddings. The amount of similarity can be determined based on comparing each of the plurality of adapted dimensionality training embeddings to a high-dimensionality training embedding of the plurality of high-dimensionality training embeddings that is equal in size (e.g., a high-dimensionality embedding that has the same number of dimensions). For example, an adapted dimensionality training embedding with 512 dimensions can be compared to a high-dimensionality training embedding with 512 dimensions and an adapted dimensionality training embedding with 128 dimensions can be compared to a high-dimensionality training embedding with 128 dimensions. This ensures that the comparison is made between embeddings that are semantically aligned and dimensionally compatible. The objective is to quantify how much of the original information, semantic meaning, and/or structural relationships can be preserved after the dimensionality reduction model's processing, even if the output dimensionality is the same as the input. This similarity determination can be used to determine the loss and subsequently guiding the model's parameter adjustments.

The computing system can determine a loss based on the amount of similarity between the high-dimensionality training embeddings and the adapted dimensionality training embeddings. This loss serves as a quantifiable determine of the discrepancy and/or error introduced by the dimensionality reduction model's transformation process. A smaller loss value indicates that the adapted dimensionality training embeddings retain a higher degree of fidelity to their high-dimensionality counterparts, implying that the model has effectively preserved the critical characteristics of the input. The determination of this loss can vary depending on the chosen similarity metric (e.g., cosine similarity) and the targeted properties of the adapted embeddings. For example, the loss function can penalize large deviations in semantic proximity and/or structural relationships between the original and adapted embeddings. This loss determination can provide a feedback signal for the subsequent optimization step.

The computing system can modify, based on the loss, a weighting of parameters of the dimensionality reduction model. The weighting of the parameters can be modified to minimize the loss. By iteratively adjusting its internal parameters, the model can be configured and/or trained to perform the transformations that result in adapted dimensionality training embeddings that are highly similar to their original high-dimensionality counterparts, thus minimizing the loss. This iterative adjustment process, can be performed via optimization algorithms which can include gradient descent, allows the dimensionality reduction model to progressively enhance its ability to generate high-fidelity adapted representations. The training can enable the model to effectively handle varying high-dimensionality inputs, producing adapted embeddings that are optimized for downstream tasks while offering benefits in terms of refined representation even when the dimensionality is not reduced.

In some embodiments, the high-dimensionality embeddings and the plurality of low-dimensionality embeddings can comprise a numerical representation of one or more images, one or more video segments, one or more text segments, and/or one or more audio segments. For example, an image can be represented as a high-dimensionality vector in which each dimension captures a specific feature and/or pixel intensity. Further, a video segment can be represented as a sequence of image embeddings, and/or a single embedding capturing motion and content. Text segments, including words, sentences, and/or entire documents, can be encoded into high-dimensionality word embeddings and/or document embeddings, capturing semantic relationships. Audio segments, which can include spoken words and/or musical notes, can also be transformed into numerical embeddings that represent their acoustic and/or semantic properties.

In some embodiments, the dimensionality reduction model can comprise a multilayer perceptron (MLP). Further, the plurality of low-dimensionality embeddings can comprise Matryoshka embeddings. Such a configuration can enable the model to learn complex, non-linear mappings from higher-dimensional embedding spaces to lower-dimensional representations. A multilayer perceptron can comprise multiple layers of interconnected nodes, where each layer can perform a transformation on its input, passing the result to the subsequent layer. This layered architecture can allow the MLP to progressively extract and refine features from the input embeddings, which can yield a more compact representation.

In some embodiments, the outputted plurality of low-dimensionality embeddings can comprise Matryoshka embeddings. Matryoshka embeddings can be configured such that each Matryoshka embedding contains one or more nested, progressively lower-dimensional embeddings.

In some embodiments, the dimensionality reduction model can be trained based on unsupervised learning operations that can comprise determining a top-k similarity loss or a pairwise similarity loss. Further, determining the top-k similarity loss and/or the pairwise similarity loss can comprise comparing document embeddings to other document embeddings. The dimensionality reduction model can be trained using various learning operations. For example, the training can be based on unsupervised learning operations. Unsupervised learning operations can comprise determining a top-k similarity loss and/or a pairwise similarity loss. Determining the top-k similarity loss and/or the pairwise similarity loss can comprise comparing embeddings (e.g., comparing document embeddings to other document embeddings, comparing image embeddings to other image embeddings, or comparing audio embeddings to other audio embeddings). Determining the top-k similarity loss can be based on performing operations to preserve the local neighborhood structure of embeddings. For example, determining the top-k similarity loss can comprise, for a given document embedding, identifying the document's k most similar neighbors in the high-dimensional space, and then assessing whether these same neighbors are still among the k most similar neighbors of its corresponding low-dimensional representation. A lower top-k similarity loss can indicate that the local relationships within the embedding space are largely maintained after dimensionality reduction. Determining the pairwise similarity loss can be based on performing operations to preserve the relative distances and/or similarities between pairs (e.g., all pairs) of embeddings (e.g., document embeddings). Further, determining the pairwise similarity loss can comprise quantifying how closely the similarity score between any two high-dimensional document embeddings is replicated in their corresponding low-dimensional counterparts. Minimizing this loss can be used to ensure that the overall structure and relationships within the embedding space are largely preserved. These unsupervised learning operations can guide the dimensionality reduction model to learn transformations that effectively compress the data while retaining information and/or relationships, without relying on labeled data.

In some embodiments, the dimensionality reduction model can be trained based on determining a ranking loss. Further, determining the ranking loss can comprise comparing corpus embeddings to other corpus embeddings, comparing query embeddings to other query embeddings, and/or comparing query-corpus pairs to other query corpus pairs. Determining the ranking loss can comprise comparing corpus embeddings to other corpus embeddings, comparing query embeddings to other query embeddings, and/or comparing query-corpus pairs to other query-corpus pairs. When comparing corpus embeddings to other corpus embeddings, the ranking loss can assess the extent to which the relative relevance of various documents within a collection is maintained after dimensionality reduction. When comparing query embeddings to other query embeddings, the loss can ensure that the relative similarity of different queries remains consistent in the reduced space. The comparison of query-corpus pairs can evaluate the preservation of relevance relationships between queries and documents. For example, if a specific document is highly relevant to a particular query in the high-dimensional space, the ranking loss can ensure that the reduced-dimensionality versions of that query and document still exhibit a strong relevance, leading to the document being ranked highly for that query. This supervised learning approach can optimize the dimensionality reduction model to generate low-dimensionality embeddings that are highly effective for tasks which can include search and retrieval, where the relative ordering of items is paramount.

The computing system can receive a query based on the high-dimensionality embeddings. This query can originate from various sources, which can include a user interacting with an application, another computational process, and/or an automated system seeking information or performing a task. The query can be expressed in various forms, which can include natural language text, an image, an audio snippet, and/or another high-dimensionality data format. For example, a user can input a textual query into a search engine, and/or an image recognition system can generate a query based on features extracted from an image. These high-dimensionality queries can be converted into a high-dimensionality embedding space for compatibility with machine learning systems, particularly those that rely on large language models (LLMs) and/or similar embedding-based architectures. The query, in its embedded form, represents the semantic content and/or intent of the user's request, allowing the computing system to efficiently search for and retrieve relevant information and/or perform relevant operations within the embedding space.

The computing system can determine, based on the query, a low-dimensionality embedding of the plurality of low-dimensionality embeddings that correspond to the query. This determination process can comprise identifying the most suitable low-dimensionality representation from a stored collection of such embeddings that best addresses the received query. The selection of a specific low-dimensionality embedding can be based on a variety of factors, including the type of query, the application context, and/or the specific computational resources available. For example, if a query is relatively simple or if the system is operating under strict latency constraints, a lower-dimensional embedding can be selected to ensure rapid response times. If the query requires a higher degree of precision and/or nuance, a slightly higher-dimensional embedding from the available low-dimensionality options can be chosen to maintain a richer representation of the underlying data. The determination process can comprise comparing the query embedding to various low-dimensionality embeddings, possibly using similarity metrics which can include cosine similarity, to find the best match or set of matches.

The computing system can access the low-dimensionality embedding (e.g., accessing the low-dimensionality embedding via a network). Accessing the low-dimensionality embedding can be based on a query (e.g., a query from a user) input into an application that implements an LLM that uses the embedding. Once the appropriate low-dimensionality embedding has been determined, the computing system can retrieve it from its storage location. This storage location can be local, which can include a high-speed solid-state drive connected to the computing system, or remote, which can include a distributed database or a cloud storage service accessible via a network (e.g., a local area network or the Internet). A selected embedding can then be accessed and utilized by the underlying LLM to generate a response, retrieve relevant documents, and/or perform other tasks.

Some of this disclosure refers to large language models as specific examples of sequence processing models but it will be appreciated that the disclosure can be equally applicable to any type of sequence processing model.

The systems, methods, devices, apparatuses, and tangible non-transitory computer-readable media in the disclosed technology can provide a variety of technical effects and benefits including improving the efficiency of resource utilization and improving the performance of computing systems. In particular, the disclosed technology can improve the efficiency of resource utilization by reducing the size of embeddings (e.g., reducing the dimensionality of embeddings) which can result in the use of less storage capacity and a reduction in the use of computational resources that are used to process the embeddings. Further, the reduction in the use of computational resources can reduce the amount of energy used in processing by a computing system as well as reducing the amount of heat produced in processing embeddings which can result in benefits to the environment.

Further, the disclosed technology can improve the performance of computing systems by generating lower-dimensionality embeddings that result in reduced latency. The low-dimensionality embeddings can be processed more rapidly with minimal or no loss in accuracy. Further, the low-dimensionality embeddings can be used on computing systems that have relatively lower computational power, thereby allowing a greater number of computing systems to leverage the various uses of machine-learning systems that use embeddings (e.g., LLMs).

The disclosed technology can be integrated into numerous machine learning applications, including image recognition systems, video analysis tools, natural language processing applications (e.g., search engines, chatbots), and audio processing systems (e.g., speech recognition, music recommendation). The ability to compress these varied high-dimensionality representations into more compact low-dimensionality forms, while maintaining critical information, is a key technical improvement offered by the disclosed technology which addresses computational and storage challenges across a wide range of data types.

Further, the disclosed technology can generate embeddings that are structured such that a single, higher-dimensional embedding contains one or more nested, progressively lower-dimensional embeddings. This nesting property can enable efficient retrieval at various computational budget levels, as a specific number of dimensions can be selected from the embedding based on the requirements of a particular application or available resources. For example, a system could store an embedding of 1024 dimensions, from which an application could efficiently extract a 512-dimension representation, a 256-dimension representation, or a 128-dimension representation, all while maintaining a high degree of semantic fidelity to the original high-dimensionality data.

As such, the disclosed technology may assist the user of a machine-learning system (e.g., an LLM) in more effectively performing a variety of tasks with the specific benefits of improving the efficiency of resource utilization and improved computational performance. Further, any of the specific benefits provided to users can be used to improve the effectiveness of a wide variety of devices and services including computing devices and/or machine-learning applications. Accordingly, the improvements offered by the disclosed technology can result in tangible benefits to a variety of devices and/or systems including mechanical, electronic, and computing systems that can leverage the benefits of low-dimensionality embeddings.

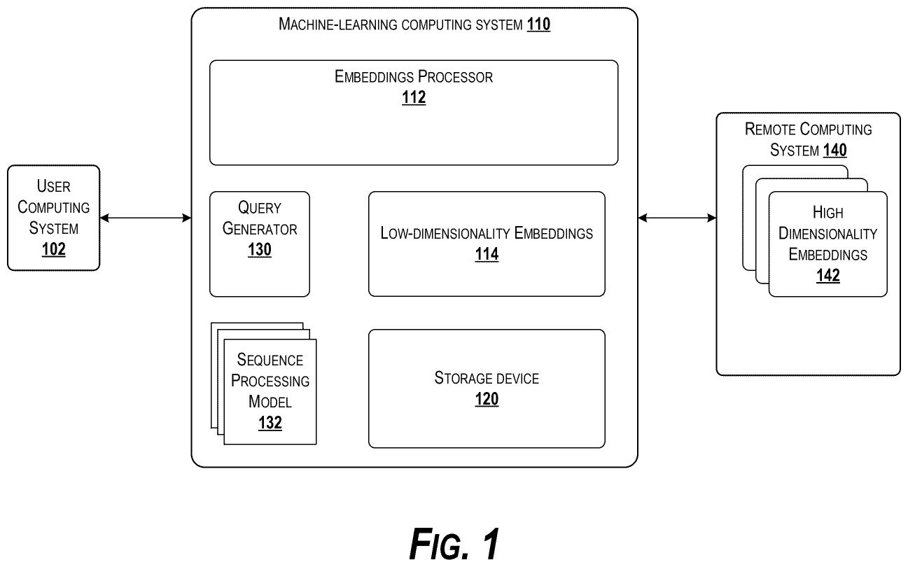

With reference now to the Figures, example embodiments of the present disclosure will be discussed in further detail. FIG. 1 is a block diagram depicting an example computing environment including a machine-learning system configured to reduce the dimensionality of embeddings according to example embodiments of the present disclosure. Computing environment 100 includes a user computing system 102, a machine-learning computing system 110, and a remote computing system 140. Although a single user computing system, machine-learning computing system, and remote computing system are shown, any number of these systems can be included in accordance with embodiments of the present disclosure.

Machine-learning computing system 110 is configured to receive one or more queries from computing devices such as user computing system 102. The machine-learning computing system 110 can include embeddings processor 112, low-dimensionality embeddings 114, storage device 120, query generator 130, and one or more sequence processing models 132. The machine-learning computing system 110 can be configured to generate low-dimensionality embeddings 114 based on input comprising high-dimensionality embeddings 142, which can be received from the remote computing system 140. The low-dimensionality embeddings 114 can be stored in the storage device 120.

Embeddings processor 112 can be configured to receive high-dimensionality embeddings 142. The high-dimensionality embeddings 142 can comprise high-dimensionality vectors comprising a first plurality of dimensions. The embeddings processor can generate a plurality of low-dimensionality embeddings 114. The plurality of low-dimensionality embeddings 114 can be based on inputting the high-dimensionality embeddings into a dimensionality reduction model that is implemented on the embeddings processor 112 and configured to reduce the dimensionality of vectors of embeddings. The plurality of low-dimensionality embeddings 114 can comprise a plurality of low-dimensionality vectors. Each of the plurality of low-dimensionality embeddings 114 can be based on the high-dimensionality vectors of the high-dimensionality embeddings 142 and can comprise a second plurality of dimensions that is smaller than the first plurality of dimensions of the high-dimensionality vectors. Furthermore, embeddings processor 112 can store the plurality of low-dimensionality embeddings 114 in the storage device 120.

Further, embeddings processor 112 can be configured to receive user queries and generate one or more query responses in response to each query. A user query can include text, audio, video, or other input modalities. In one specific example, user query includes a natural language input requesting performance of a task by a sequence processing model 132. For instance, a user query can include a natural language input requesting that primary sequence processing model generate an e-mail, edit a picture, write a letter, determine directions to a location, prepare a resume, write computer code, create a recipe, post to a social media application, or one of the other myriad tasks for which sequence processing models can be configured.

In response to a particular query, query processor can invoke or otherwise communicate with sequence processing model 132 to generate a plurality of low-dimensionality embeddings based on high-dimensionality embeddings from remote computing system 140.

Storage device 120 can store low-dimensionality embeddings generated by the machine-learning computing system 110. Query generator 130 can be configured to generate one or more queries for sequence processing model(s) based at least in part on a particular user query and/or a query generated by the embeddings processor 112. Query generator 130 can generate a query that can be used to train the embeddings processor 112.

Embeddings processor 112 can obtain one or more outputs from the sequence processing model 132 in response to the one or more queries generated by query generator 130. Embeddings processor 112 can generate one or more query responses to the particular query based at least on the one or more outputs from the sequence processing model 132.

In some examples, machine-learning computing system 110 can be implemented by one or more first computing devices, user computing system 102 can be implemented by one or more second computing devices, and remote computing system 140 can be implemented by one or more third computing devices. For instance, computing environment 100 can be implemented as a client server computing environment, including one or more client computing devices that implement the user computing system 102, one or more server computing devices that implement the machine-learning computing system 110, and/or one or more server computing devices implementing remote computing system 140.

User computing system 102, machine-learning computing system 110, and remote computing system 140 can be connected by and communicate through one or more networks (not shown). Any number of client computing devices and/or server computing devices can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In some example embodiments, a client computing device that implements the user computing system 102 can be any suitable device, including, but not limited to, a smartphone, a tablet, a laptop, a desktop computer, or any other computer device that is configured such that it can allow a user to access remote computing devices over a network. The client computing devices can include one or more processor(s), memory, and a display as described in more detail hereinafter. The client computing devices can execute one or more client applications such as a web browser, email application, chat application, video conferencing application, word processing application or the like.

A server computing device implementing machine-learning computing system or and/or remote computing system 140 can include one or more processor(s) and memory implementing the respective computing systems. The server computing system can be in communication with the one or more client computing device(s) using a network communication device that is not pictured.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory, and executed by a processor or can be provided from computer program products, for example computer executable instructions, that are stored in a tangible computer-readable storage medium such as RAM, hard disk, or optical or magnetic media.

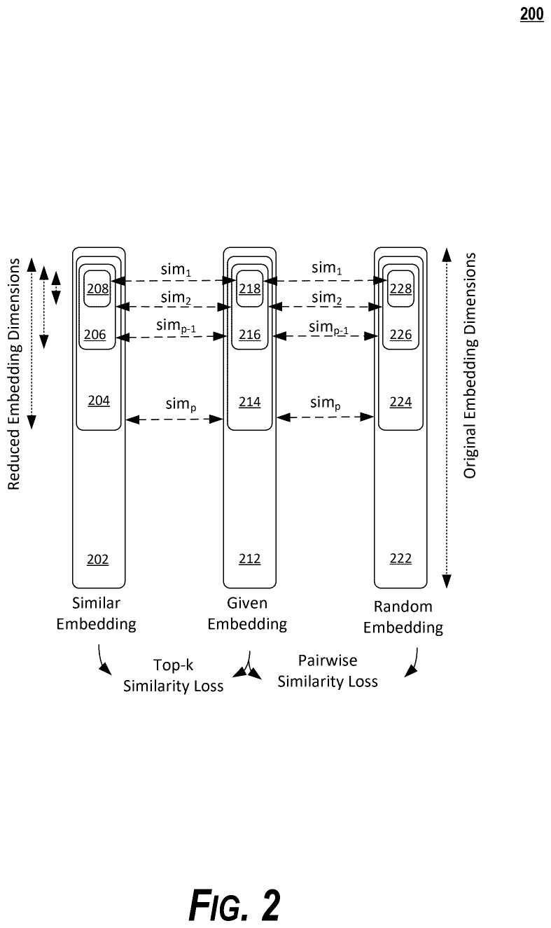

FIG. 2 is an example of loss functions including top-k loss and pairwise similarity loss that can be used in training a dimensionality reduction model based on according to example embodiments of the present disclosure. In FIG. 2, top-k similarity loss and pairwise similarity loss functions that are employed within the dimensionality reduction model framework are shown. A visual representation of these loss functions, showing their application across multiple reduced dimensionality embeddings (e.g., Matryoshka embeddings) of varying dimensions is provided in FIG. 2. The construction of reduced embeddings can be achieved by extracting the initial m dimensions from the original embedding vectors.

FIG. 2 shows distinct loss functions that can be used within a dimensionality reduction model framework. In some embodiments, the loss functions can be used to train the dimensionality reduction model through unsupervised learning operations. FIG. 2 shows representations of embeddings 200 which comprise a similar embedding 202, a given embedding 212, and a random embedding 222. Each of the embeddings can be associated with a plurality of lower-dimensionality embeddings that have fewer dimensions. For example, the similar embedding 202 can be associated with an embedding 204 that includes a subset of the dimensions of the given embedding 212 and has fewer dimensions than the given embedding 212, an embedding 206 that includes a subset of the dimensions of the embedding 204 and has fewer dimensions than the embedding 204, and an embedding 208 that includes a subset of the dimensions of the embedding 206 and has fewer dimensions than the embedding 206.

Further, the given embedding 212 can be associated with an embedding 214 that includes a subset of the dimensions of the given embedding 212 and has fewer dimensions than the given embedding 212, an embedding 216 that includes a subset of the dimensions of the embedding 214 and has fewer dimensions than the embedding 214, and an embedding 218 that includes a subset of the dimensions of the embedding 216 and has fewer dimensions than the embedding 216.

Additionally, the random embedding 222 can be associated with an embedding 224 that includes a subset of the dimensions of the given embedding 212 and has fewer dimensions than the given embedding 212, an embedding 226 that includes a subset of the dimensions of the embedding 224 and has fewer dimensions than the embedding 224, and an embedding 228 that includes a subset of the dimensions of the embedding 226 and has fewer dimensions than the embedding 226.

The similar embedding 202 and the associated embeddings 204-208 can be generated based on the use of pairwise similarity loss operations on the given embedding 212. The pairwise loss function, denoted as Lₚₐᵢᵣ, can be configured to preserve the pairwise similarity between the original embeddings in their reduced-dimension form (e.g., Matryoshka form), which can be expressed as:

$${ℒ}_{pair} = {\sum }_{i} {\sum }_{j} {\sum }_{m} \vert Sim ( {ce}_{i} , {ce}_{j} ) - Sim ( f ( {ce}_{i} ) [ : m ] , f ( {ce}_{j} ) [ : m ] ) \vert$$

In the preceding equation for the pairwise loss function, Sim represents a similarity function, which can comprise a cosine similarity. Further, the pairwise similarity loss can measure the degree to which the relative distances or similarities between pairs of high-dimensionality embeddings are maintained in their low-dimensionality counterparts. For example, if two high-dimensionality document embeddings have a specific cosine similarity score, the pairwise loss can quantify how closely their corresponding low-dimensionality embeddings replicate that same similarity score. By minimizing this loss, the dimensionality reduction model can be configured and/or trained to learn to maintain a consistent mapping of global relationships, which can result in the overall structure of the embedding space being preserved.

The random embedding 222 and the associated embeddings 224-228 can be generated based on the use of top-k similarity loss operations on the given embedding 212. The top-k loss, denoted as Lₜₒₚₖ, can be configured to focus on preserving local similarity relationships among neighboring embeddings:

$${ℒ}_{top , k} = {\sum }_{i} {\sum }_{j ∈ {NN}_{k} ( i )} {\sum }_{m} \vert Sim ( {ce}_{i} , {ce}_{j} ) - Sim ( f ( {ce}_{i} ) [ : m ] , f ( {ce}_{j} ) [ : m ] ) \vert$$

In the preceding equation for the top-k loss function, NNₖ(i) denotes the set of the top k most similar embeddings to ceᵢ. The top-k loss function can measure how well the set of the top-k most similar embeddings to a given high-dimensionality embedding are retained within the top-k most similar embeddings of its corresponding low-dimensionality embedding. For example, if an original document embedding is close to ten other document embeddings in the high-dimensional space, the top-k similarity loss can assess whether the reduced-dimensionality version of that document embedding is still close to those same ten other document embeddings in the low-dimensional space. A lower value for the top-k loss can indicate that the local structure and neighborhood relationships of the embedding space are largely preserved after dimensionality reduction. In some embodiments, determination of top-k loss can be used in tasks including information retrieval in which the proximity of embeddings can be positively correlated with their semantic relevance.

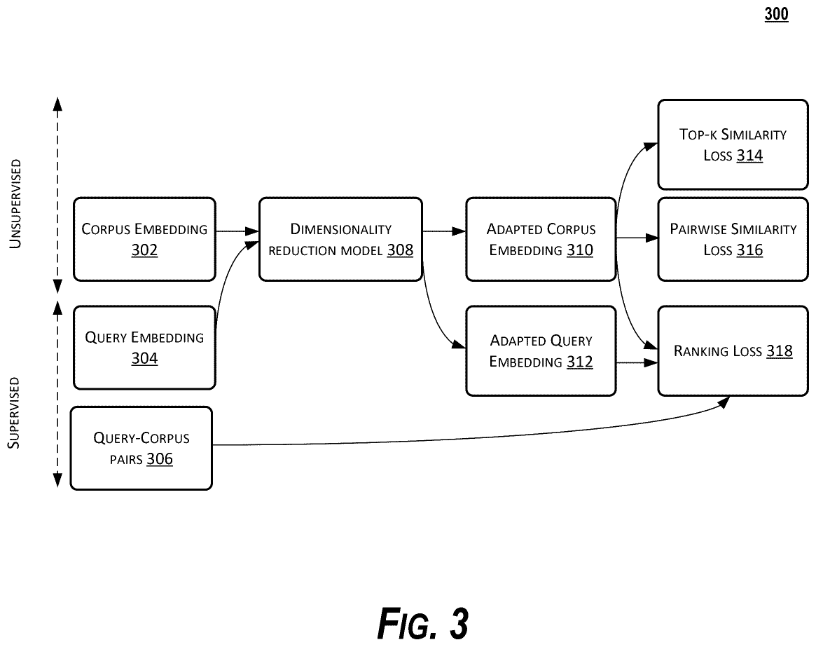

FIG. 3 is a block diagram depicting an example supervised and unsupervised training of dimensionality reduction models according to example embodiments of the present disclosure. Example computing environment 300 can be used to implement a machine-learning computing system 110 as depicted in FIG. 1. FIG. 3 shows examples of unsupervised and supervised dimensionality reduction frameworks. Using unsupervised dimensionality techniques the corpus embeddings 302 can be used as input to the dimensionality reduction model 308 which can generate the adapted corpus embedding 310 based on the corpus embeddings 302. Further, the dimensionality reduction model 308 can generate the adapted query embedding 312 based on the query embeddings 304. Configuration and/or training of the dimensionality reduction model 308 can be achieved by using various training operations which can include implementing the top-k similarity loss operations 314, the pairwise similarity loss operations 316, and/or the ranking loss operations 318. The training operations can be used across a plurality of high-dimensionality embeddings with outputs that comprise various reduced dimensionality embeddings.

The unsupervised dimensionality reduction configuration can use the corpus embeddings 302 as input to the dimensionality reduction model 308. In some embodiments, the corpus embeddings 302 can represent a numerical encoding of data (e.g., a document or a text segment, which can have a high dimensionality). In the unsupervised dimensionality reduction configuration, the dimensionality reduction model 308 can processes the corpus embeddings 302 to generate the adapted corpus embedding 310. Training and/or configuration of the dimensionality reduction model 308 within the unsupervised configuration can comprise performance of the top-k similarity loss operations 314 and/or the pairwise similarity loss operations 316. The top-k similarity loss operations 314 can evaluate the preservation of local neighborhood structures among embeddings. This can comprise assessing whether the k-nearest neighbors of an original high-dimensionality corpus embedding are maintained within the k-nearest neighbors of its corresponding adapted low-dimensionality corpus embedding.

The pairwise similarity loss operations 316 can evaluate the preservation of relative distances or similarities between all pairs of corpus embeddings after dimensionality reduction. The top-k similarity loss operations 314 and/or the pairwise similarity loss operations 316 can be performed across a plurality of low-dimensionality embeddings with various reduced dimensions, allowing the dimensionality reduction model to learn a transformation that maintains significant and/or essential relationships regardless of the target output dimensionality. The combination of these losses can guide the dimensionality reduction model to minimize the information loss during dimensionality reduction and can be configured to focus on maintaining the inherent structural properties of the embedding space without requiring explicit labels and/or external supervision.

The supervised dimensionality reduction configuration can use the query embeddings 304 and/or the query-corpus pairs 306 as input. In some embodiments, the query embeddings 304 can represent a numerical encoding of a search query, which can have a high dimensionality. A query-corpus pair 306 can represent a relationship between a query and a relevant document or text segment. In the supervised configuration, the dimensionality reduction model 308 can receive the corpus embeddings 302, the query embeddings 304, and/or the query-corpus pairs 306. The dimensionality reduction model 308 can then process these inputs to generate the adapted corpus embeddings 310 based on the corpus embeddings 302 and/or the adapted query embeddings based on the query embeddings 304. The inclusion of the query embeddings 304 and/or the query-corpus pairs 306 can allow for a more targeted training approach.

The more targeted training approach can improve the performance of retrieval tasks in which alignment of queries with relevant documents can be significant. A ranking loss can be incorporated alongside the top-k similarity loss operations 314 and/or the pairwise similarity loss operations 316 to facilitate the training of the dimensionality reduction model. The ranking loss operations 318 can be configured to align the ranking between a query and a corpus, considering different dimensionality reduction model embedding dimensions. The ranking loss can measure how well the relative relevance of documents to a query is preserved after both the query and corpus embeddings have undergone dimensionality reduction. For example, if a specific document is highly relevant to a query in the high-dimensional space, the ranking loss can ensure that the reduced-dimensionality versions of that query and document still exhibit a strong relevance, placing the document high in the retrieval results for that query. In some embodiments, this direct optimization for retrieval performance can lead to improved accuracy and efficiency in applications including search engines or recommendation systems.

In the supervised configuration the query embeddings 304 and query-corpus pairs 306 can be provided as inputs to the dimensionality reduction model 308. A ranking loss can be incorporated alongside the top-k and pairwise losses to facilitate the training of the dimensionality reduction model. A dimensionality reduction model ranking loss, denoted as Lᵣₐₙₖ, can be used to align the ranking between query and corpus considering different dimensionality reduction model embedding dimensions. The ranking function can be expressed as:

$${ℒ}_{rank} = {\sum }_{i} {\sum }_{j} {\sum }_{k} {\sum }_{m} I ( {y}_{ij} > {y}_{ik} ) ( {y}_{ij} - {y}_{ik} ) log ( 1 + exp ( {s}_{ik} [ : m ] - {s}_{ij} [ : m ] ) )$$

In the preceding equation for ranking loss, sij [: m] represents the cosine similarity between the adapted query embedding q\hat{ }ei[: m] (where q\hat{ }ei=qei+f(qei)) and adapted corpus embedding c\hat{ }ej [: m]. In some embodiments, losses can be computed across low-dimensionality embeddings with different reduced dimensions (e.g., across low-dimensionality embeddings that comprise embeddings with vectors that have 512 dimensions, 256 dimensions, and 128 dimensions).

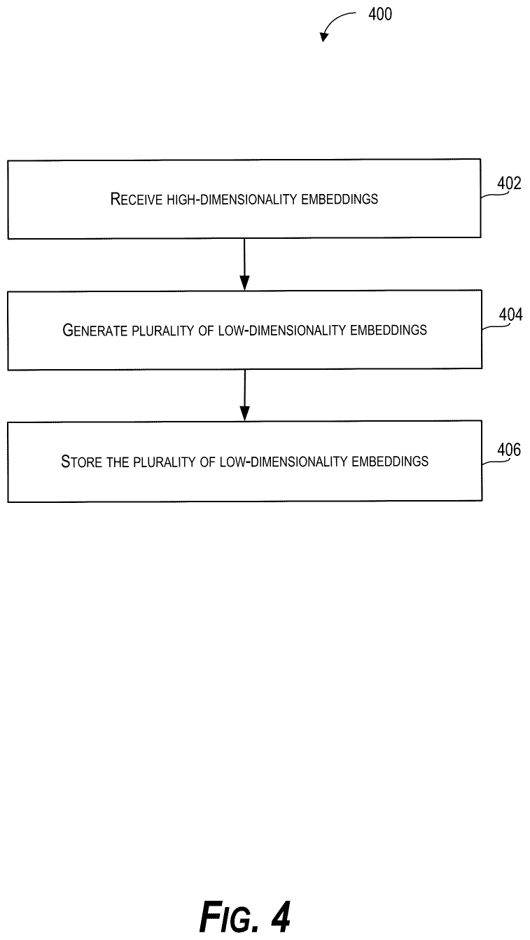

FIG. 4 depicts a flow chart diagram of an example method to reduce the dimensionality of embeddings according to example embodiments of the present disclosure. One or more portions of the method 400 can be executed and/or implemented on one or more computing devices or computing systems comprising, for example, the computing devices and/or computing systems described herein (e.g., the computing device 40, the server computing system 60, the model development platform system 70, the third-party system(s) 80, the user computing system 102, the machine-learning computing system 110, and/or the remote computing system 140). Further, one or more portions of the method 400 can be executed or implemented as an algorithm on the hardware devices or systems disclosed herein. FIG. 4 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 402, the method 400 can include receiving one or more embeddings. The one or more embeddings can comprise high-dimensionality embeddings which can comprise high-dimensionality vectors. The high-dimensionality vectors can comprise a first plurality of dimensions. For example, the machine-learning computing system 110 can receive one or more embeddings from a remote computing system.

At 404, the method 400 can include generating a plurality of low-dimensionality embeddings. Generating the plurality of low-dimensionality embeddings can be based on inputting the high-dimensionality embeddings into a dimensionality reduction model that is configured to reduce the dimensionality of vectors of embeddings. The plurality of low-dimensionality embeddings can comprise a plurality of low-dimensionality vectors. The plurality of low-dimensionality vectors can be based on the high-dimensionality vectors of the high-dimensionality embeddings. For example, the machine-learning computing system 110 can generate each of the plurality of low-dimensionality vectors which can be based on a respective high-dimensionality vector of the high-dimensionality embeddings. The plurality of high-dimensionality vectors can comprise a second plurality of dimensions that is smaller than the first plurality of dimensions of the high-dimensionality vectors.

At 406, the method 400 can include storing the plurality of low-dimensionality embeddings. For example, the plurality of low-dimensionality embeddings can be stored in one or more remote storage devices (e.g., storage devices of the remote computing system 140) that are accessible by a user computing device (e.g., the user computing system 102).

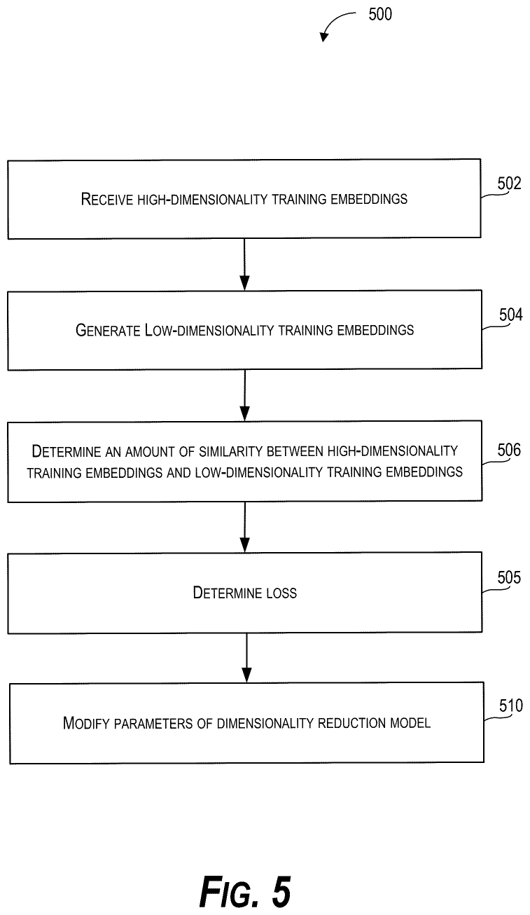

FIG. 5 depicts a flow chart diagram of an example method to train a dimensionality reduction model that is configured to reduce the dimensionality of embeddings according to example embodiments of the present disclosure. One or more portions of the method 500 can be executed and/or implemented on one or more computing devices or computing systems comprising, for example, the computing devices and/or computing systems described herein (e.g., the computing device 40, the server computing system 60, the model development platform system 70, the third-party system(s) 80, the user computing system 102, the machine-learning computing system 110, and/or the remote computing system 140). Further, one or more portions of the method 500 can be executed or implemented as an algorithm on the hardware devices or systems disclosed herein. In some embodiments, one or more portions of the method 500 can be performed as part of the method 400 that is described with respect to FIG. 4. FIG. 5 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 502, the method 500 can include receiving high-dimensionality training embeddings comprising high-dimensionality training vectors comprising a third plurality of dimensions. For example, the machine-learning computing system 110 can receive high-dimensionality training embeddings from a remote computing system.

At 504, the method 500 can include generating based on inputting the high-dimensionality training embeddings into the dimensionality reduction model, low-dimensionality training embeddings comprising low-dimensionality training vectors comprising a fourth plurality of dimensions that is smaller than the third plurality of dimensions of the high-dimensionality training embeddings. Generating low-dimensionality training embeddings can comprise a computing system (e.g., the machine-learning computing system 110) implementing the high-dimensionality reduction model which can process the high-dimensionality training embeddings and generate the low-dimensionality training embeddings.

At 506, the method 500 can include determining an amount of similarity between the high-dimensionality training embeddings and the low-dimensionality training embeddings. For example, the machine-learning computing system 110 can determine an amount of similarity between the high-dimensionality training embeddings and the low-dimensionality training embeddings based on determination of a top-k similarity between the high-dimensionality training embeddings and the low-dimensionality training embeddings.

At 508, the method 500 can include determining a loss based on the amount of similarity between the high-dimensionality training embeddings and the low-dimensionality training embeddings. For example, over a plurality of iterations, the machine-learning computing system 110 can determine a loss based on the amount of similarity between the high-dimensionality training embeddings and the low-dimensionality training embeddings.

At 510, the method 500 can include modifying based on the loss, a weighting of parameters of the dimensionality reduction model. A weighting of the parameters can be modified to minimize the loss. For example, the machine-learning computing system 110 can modify a plurality of weights of a plurality of parameters of the dimensionality reduction model such that the weights of the plurality of parameters that contribute to reducing the loss (e.g., the parameters that increase the accuracy of the dimensionality reduction model generating training output that is accurate) are increased and/or the weights of the plurality of parameters that contribute to increasing the loss (e.g., the parameters that decrease the accuracy of the dimensionality reduction model generating training output that is accurate) are decreased. The plurality of weights of the plurality of parameters can be modified until some threshold loss (e.g., a minimized loss) that corresponds to a high accuracy of the training output is exceeded.

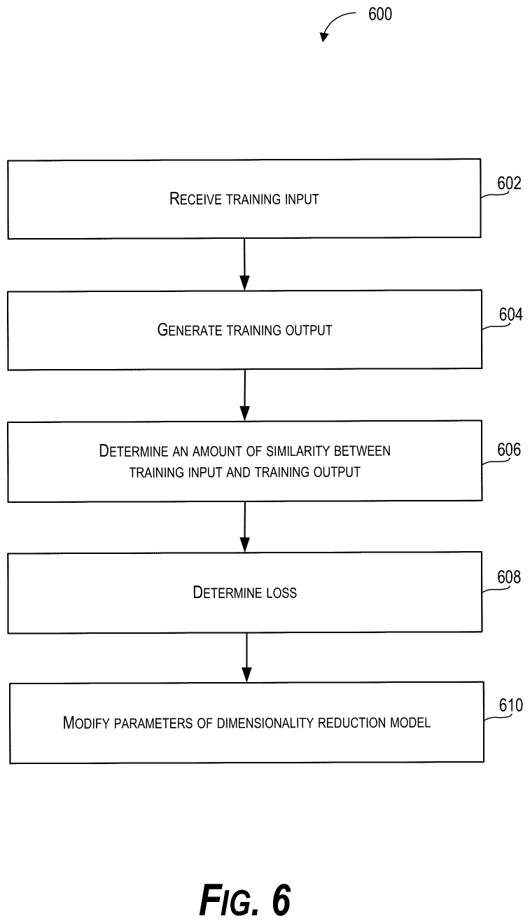

FIG. 6 depicts a flow chart diagram of an example method to train a dimensionality reduction model that is configured to reduce the dimensionality of embeddings according to example embodiments of the present disclosure. One or more portions of the method 600 can be executed and/or implemented on one or more computing devices or computing systems comprising, for example, the computing devices and/or computing systems described herein (e.g., the computing device 40, the server computing system 60, the model development platform system 70, the third-party system(s) 80, the user computing system 102, the machine-learning computing system 110, and/or the remote computing system 140). Further, one or more portions of the method 600 can be executed or implemented as an algorithm on the hardware devices or systems disclosed herein. In some embodiments, one or more portions of the method 600 can be performed as part of the method 400 that is described with respect to FIG. 4. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include receiving training input comprising high-dimensionality training corpus embeddings, high-dimensionality training query embeddings, and/or high-dimensionality query-corpus pairs. For example, the machine-learning computing system 110 can receive training input comprising high-dimensionality training corpus embeddings, high-dimensionality training query embeddings, and high-dimensionality query-corpus pairs.

At 604, the method 600 can include generating based on inputting the training input into the dimensionality reduction model, training output comprising low-dimensionality training corpus embeddings and low-dimensionality training query embeddings. A dimensionality of the low-dimensionality training corpus embedding can be lower than a dimensionality of the high-dimensionality training corpus embedding. Further, a dimensionality of the low-dimensionality training query embedding can be lower than a dimensionality of the high-dimensionality training query embedding. For example, the machine-learning computing system 110 can implement one or more machine-learned models comprising a dimensionality reduction model. Further, based on inputting the training input into the dimensionality reduction model, the dimensionality reduction model can perform one or more operations on the training input and generate the training output.

At 606, the method 600 can include determining an amount of similarity between the training input and the training output. For example, the machine-learning computing system 110 can determine an amount of similarity between the training input and the training output based on implementation of a cosine similarity algorithm on the training input and the training output.

At 608, the method 600 can include determining a loss based on the amount of similarity between the training input and the training output. For example, over a plurality of iterations, the machine-learning computing system 110 can determine a loss based on the amount of similarity between the training input and the training output.

At 610, the method 600 can include modifying, based on the loss, a weighting of parameters of the dimensionality reduction model. Weighting of the parameters can be modified to minimize the loss. For example, the machine-learning computing system 110 can modify a plurality of weights of a plurality of parameters of the dimensionality reduction model such that the weights of the plurality of parameters that contribute to reducing the loss (e.g., the parameters that increase the accuracy of the dimensionality reduction model generating training output that is accurate) are increased and/or the weights of the plurality of parameters that contribute to increasing the loss (e.g., the parameters that decrease the accuracy of the dimensionality reduction model generating training output that is accurate) are decreased. The plurality of weights of the plurality of parameters can be modified until some threshold loss (e.g., a minimized loss) that corresponds to a high accuracy of the training output is exceeded.

### Example Machine-Learned Models

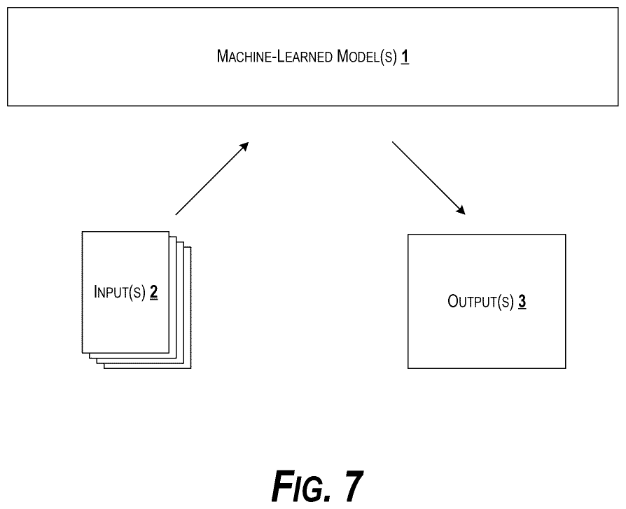

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism, such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

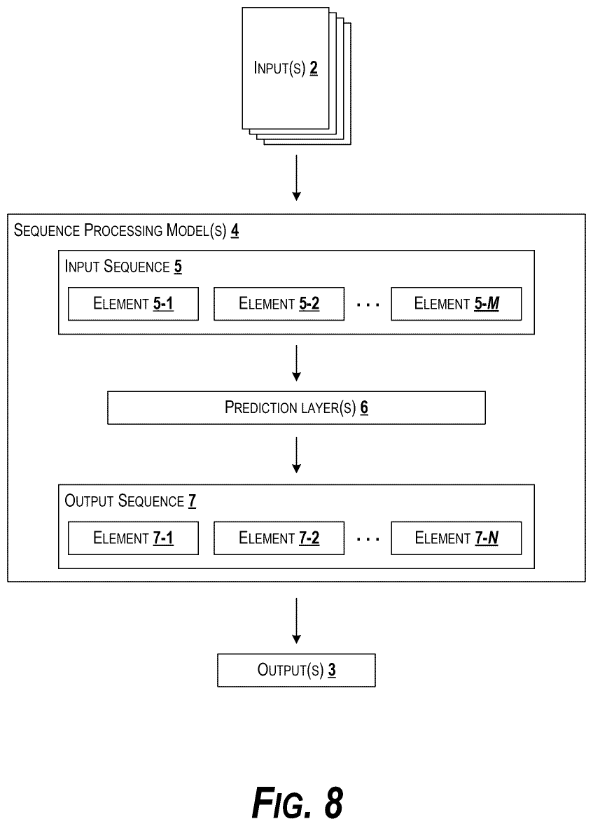

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), //aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

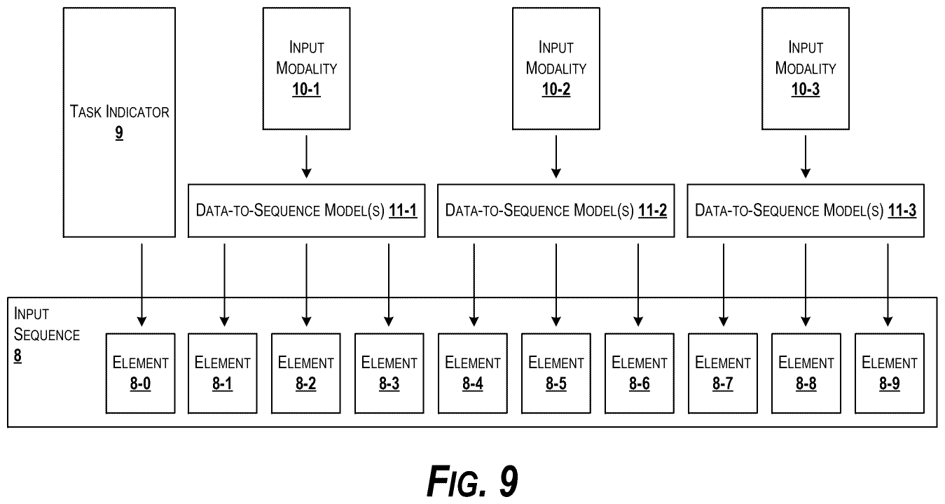

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

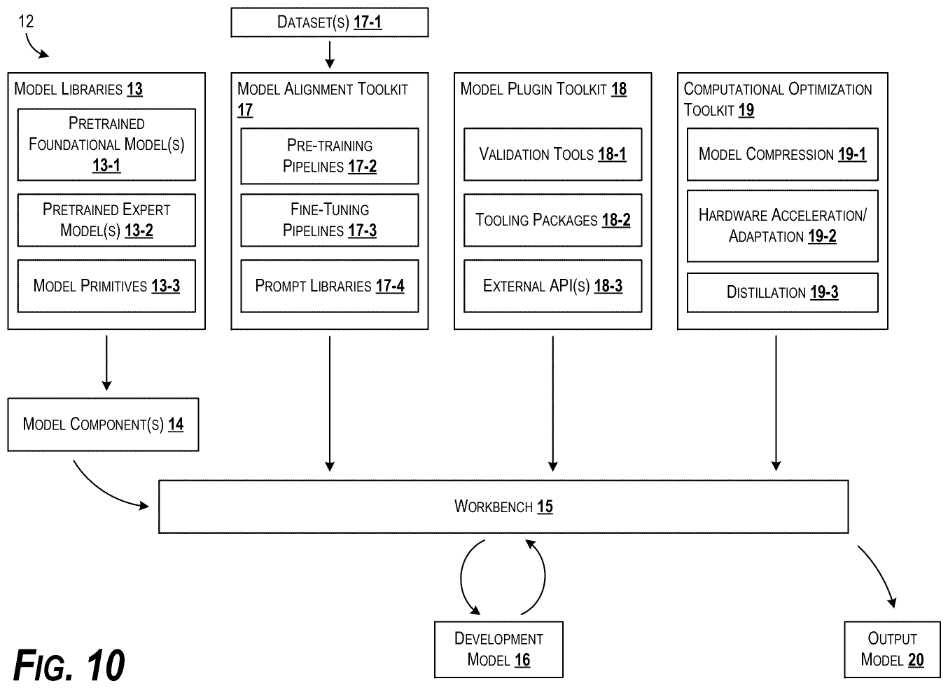

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

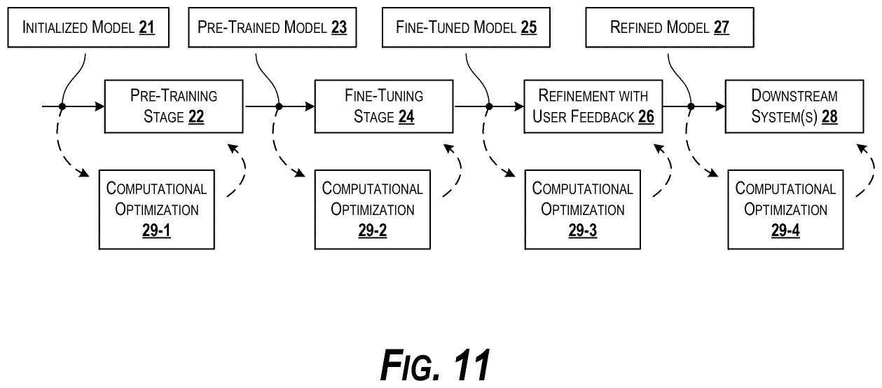

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

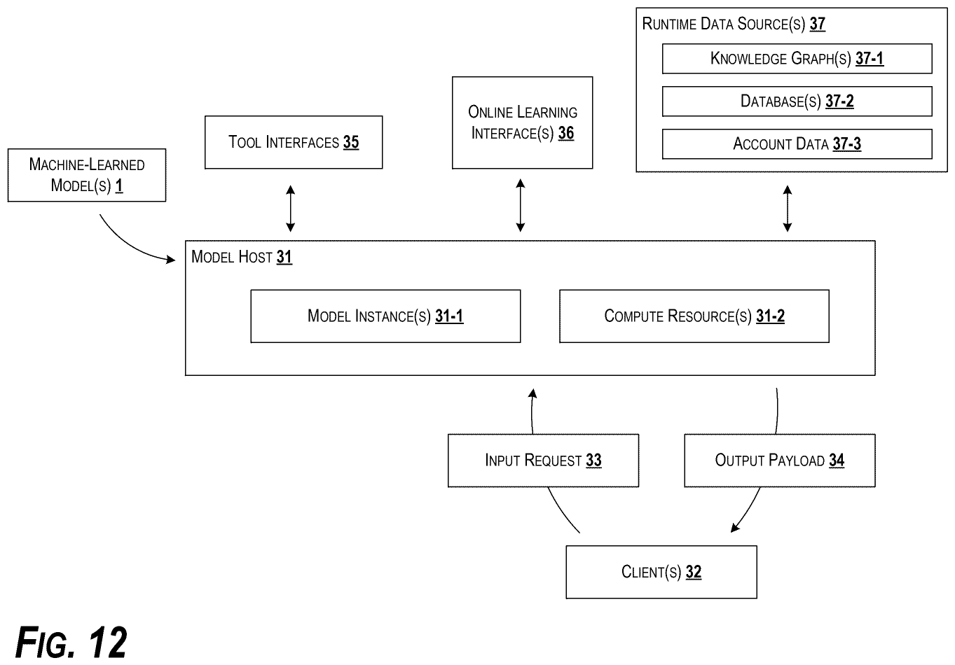

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external, or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually may not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g. Input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

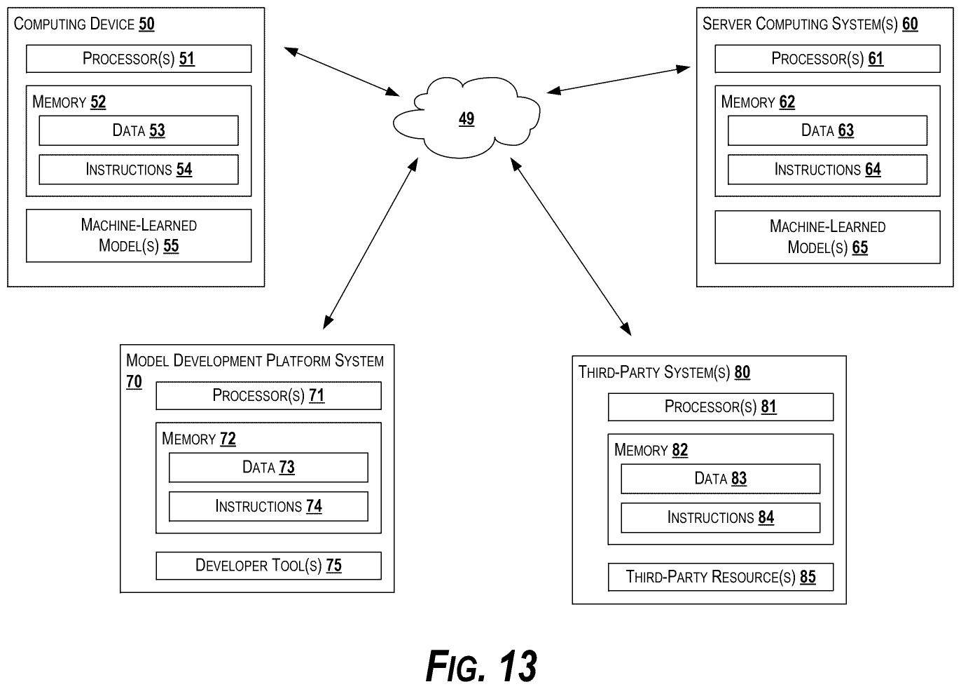

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). The computing device 50 can include any of the features and/or capabilities of the user computing system 102. An example server computing system 60 is described as an example of a server computing system that can perform any aspect of the present disclosure (e.g., implementing model host 31, client(s) 32, or both). The server computing system 60 can include any of the features and/or capabilities of the machine-learning computing system 110 and/or the remote computing system 140. Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. The model development platform system 70 can include any of the features and/or capabilities of the machine-learning computing system 110 and/or the remote computing system 140. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.). The third-party system(s) 80 can include any of the features and/or capabilities of the machine-learning computing system 110 and/or the remote computing system 140.

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third-party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third-party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. One or more processors 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by one or more processors 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause the third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

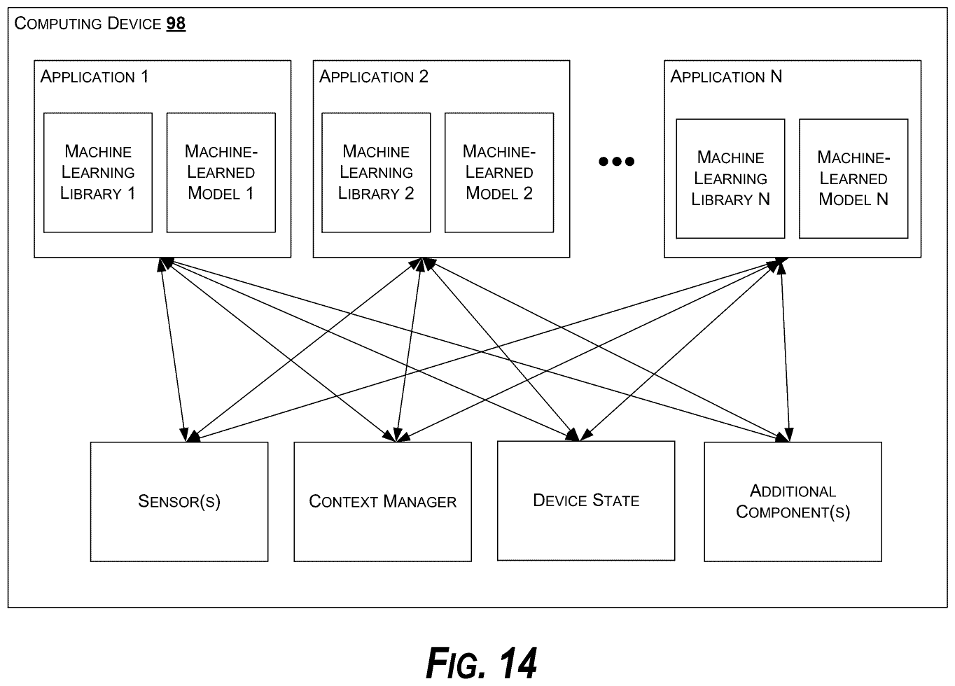

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

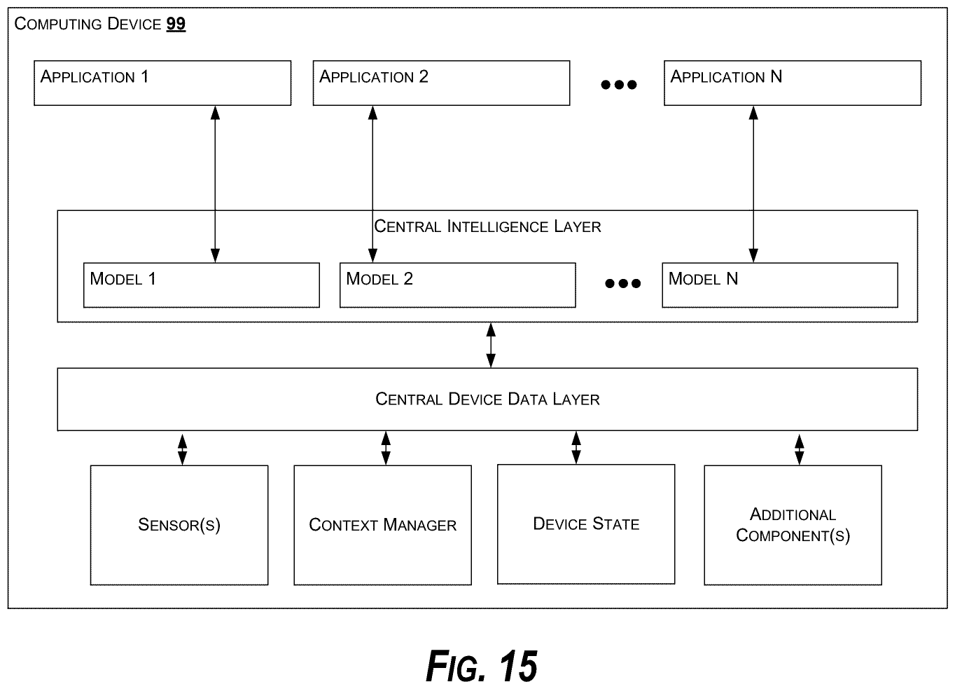

FIG. 15 is a block diagram of an example computing device that performs according to example embodiments of the present disclosure. Computing device 99 can be the same as or different from computing device 98. Computing device 99 can be a user computing device or a server computing device (e.g., computing device 50, server computing system(s) 60, etc.).

Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The terms “machine-learning model” and “machine-learned model” can be used interchangeably. A machine-learning model can refer to a machine-learned model. Further, a machine-learned model can refer to a machine-learning model.

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method of reducing a dimensionality of embeddings, the computer-implemented method comprising:
receiving, by a computing system comprising one or more processors, high-dimensionality embeddings comprising high-dimensionality vectors comprising a first plurality of dimensions;
generating, by the computing system, based on inputting the high-dimensionality embeddings into a dimensionality reduction model that is configured to reduce the dimensionality of vectors of embeddings, a plurality of low-dimensionality embeddings comprising a plurality of low-dimensionality vectors, wherein each of the plurality of low-dimensionality vectors is based on the high-dimensionality vectors of the high-dimensionality embeddings and comprises a second plurality of dimensions that is smaller than the first plurality of dimensions of the high-dimensionality vectors; and
storing, by the computing system, the plurality of low-dimensionality embeddings.

2. The computer-implemented method of claim 1, further comprising:
receiving, by the computing system, high-dimensionality training embeddings comprising high-dimensionality training vectors comprising a third plurality of dimensions;
generating, by the computing system, based on inputting the high-dimensionality training embeddings into the dimensionality reduction model, low-dimensionality training embeddings comprising low-dimensionality training vectors comprising a fourth plurality of dimensions that is smaller than the third plurality of dimensions of the high-dimensionality training embeddings;
determining, by the computing system, an amount of similarity between the high-dimensionality training embeddings and the low-dimensionality training embeddings;
determining, by the computing system, a loss based on the amount of similarity between the high-dimensionality training embeddings and the low-dimensionality training embeddings; and
modifying, by the computing system, based on the loss, a weighting of parameters of the dimensionality reduction model, wherein the weighting of the parameters is modified to minimize the loss.

3. The computer-implemented method of claim 2, wherein the determining, by the computing system, an amount of similarity between the high-dimensionality training embeddings and the low-dimensionality training embeddings comprises:
determining, by the computing system, a cosine similarity between the high-dimensionality embeddings and the low-dimensionality embeddings.

4. The computer-implemented method of claim 2, wherein the determining, by the computing system, a loss based on the amount of similarity between the high-dimensionality training embeddings and the low-dimensionality training embeddings, a loss comprises:
determining, by the computing system, a top-k similarity loss based on the amount of similarity between the high-dimensionality training embeddings and the low-dimensionality training embeddings.

5. The computer-implemented method of claim 2, wherein the determining, by the computing system, a loss based on the amount of similarity between the high-dimensionality training embeddings and the low-dimensionality training embeddings, a loss comprises:
determining, by the computing system, a pairwise loss based on the amount of similarity between the high-dimensionality training embeddings and the low-dimensionality training embeddings.

6. The computer-implemented method of claim 2, wherein the determining, by the computing system, a loss based on the amount of similarity between the high-dimensionality training embeddings and the low-dimensionality training embeddings, a loss comprises:
comparing, by the computing system, the high-dimensionality training vectors to the low-dimensionality training vectors; and
determining, by the computing system, the amount of similarity based on the comparison of the high-dimensionality training vectors to the low-dimensionality training vectors.

7. The computer-implemented method of claim 2, wherein the loss is positively correlated with the amount of similarity between the high-dimensionality training embeddings and the low-dimensionality training embeddings at a plurality of different fourth pluralities of dimensions that are smaller than the third plurality of dimensions of the high-dimensionality training embeddings.

8. The computer-implemented method of claim 1, further comprising:
receiving, by the computing system, training input comprising high-dimensionality training corpus embeddings, high-dimensionality training query embeddings, and high-dimensionality query-corpus pairs;
generating, by the computing system, based on inputting the training input into the dimensionality reduction model, training output comprising low-dimensionality training corpus embeddings and low-dimensionality training query embeddings, wherein a dimensionality of the low-dimensionality training corpus embeddings is lower than a dimensionality of the high-dimensionality training corpus embeddings, and wherein a dimensionality of the low-dimensionality training query embeddings is lower than a dimensionality of the high-dimensionality training query embeddings;
determining, by the computing system, an amount of similarity between the training input and the training output;
determining, by the computing system, a loss based on the amount of similarity between the training input and the training output; and
modifying, by the computing system, based on the loss, a weighting of parameters of the dimensionality reduction model, wherein the weighting of the parameters is modified to minimize the loss.

9. The computer-implemented method of claim 8, wherein the determining, by the computing system, an amount of similarity between the training input and the training output comprises:
determining, by the computing system, a cosine similarity between the high-dimensionality training corpus embeddings and the low-dimensionality training corpus embeddings; and
determining, by the computing system, a cosine similarity between the high-dimensionality training query embeddings and the low-dimensionality training query embeddings.

10. The computer-implemented method of claim 8, wherein the determining, by the computing system, a loss based on the amount of similarity between the training input and the training output comprises:
determining, by the computing system, a ranking loss based on the amount of similarity between the high-dimensionality training corpus embeddings and the low-dimensionality training corpus embeddings; and
determining, by the computing system, the ranking loss based on the amount of similarity between the high-dimensionality training query embeddings and the low-dimensionality training query embeddings.

11. The computer-implemented method of claim 8, wherein the loss is positively correlated with the amount of similarity between the training input and the training output at a plurality of different dimensionalities in which the dimensionality of the training output is smaller than the dimensionality of the training input.

12. The computer-implemented method of claim 1, further comprising:
receiving, by the computing system, a plurality of high-dimensionality training embeddings comprising a plurality of high-dimensionality training vectors comprising a fifth plurality of dimensions of different sizes;
generating, by the computing system, based on inputting the high-dimensionality training embeddings into the dimensionality reduction model, a plurality of adapted dimensionality training embeddings corresponding to the plurality of high-dimensionality training embeddings and comprising a plurality of adapted dimensionality training vectors that are equal in size to each of the plurality of high-dimensionality training vectors respectively;
determining, by the computing system, an amount of similarity between the high-dimensionality training embeddings and the adapted dimensionality training embeddings;
determining, by the computing system, a loss based on the amount of similarity between the high-dimensionality training embeddings and the adapted dimensionality training embeddings; and
modifying, by the computing system, based on the loss, a weighting of parameters of the dimensionality reduction model, wherein the weighting of the parameters is modified to minimize the loss.

13. The computer-implemented method of claim 1, wherein the dimensionality reduction model comprises a multilayer perceptron (MLP), wherein the plurality of low-dimensionality embeddings comprise Matryoshka embeddings, and wherein the high-dimensionality embeddings and the plurality of low-dimensionality embeddings comprise a numerical representation of one or more images, one or more video segments, one or more text segments, or one or more audio segments.

14. The computer-implemented method of claim 1, wherein the dimensionality reduction model is trained based on unsupervised learning operations comprising determining a top-k similarity loss or a pairwise similarity loss, and wherein determining the top-k similarity loss or the pairwise similarity loss comprises comparing document embeddings to other document embeddings.

15. The computer-implemented method of claim 1, wherein the plurality of low-dimensionality embeddings comprise two or more low-dimensionality embeddings that have a lower dimensionality than the high-dimensionality embeddings.

16. The computer-implemented method of claim 1, wherein the plurality of low-dimensionality embeddings have a plurality of different vectors that have a plurality of different dimensions.

17. The computer-implemented method of claim 1, wherein the dimensionality reduction model is trained based on determining a ranking loss, and wherein determining the ranking loss comprises comparing corpus embeddings to other corpus embeddings, comparing query embeddings to other query embeddings, or comparing query-corpus pairs to other query corpus pairs.

18. The computer-implemented method of claim 1, further comprising:
receiving, by the computing system, a query based on the high-dimensionality embeddings;
determining, by the computing system, based on the query, a low-dimensionality embedding of the plurality of low-dimensionality embeddings that corresponds to the query; and
accessing, by the computing system, a low-dimensionality embedding of the plurality of low-dimensionality embeddings.

19. One or more tangible non-transitory computer-readable media storing computer-readable instructions that when executed by one or more processors cause the one or more processors to perform operations, the operations comprising:
receiving a high-dimensionality embeddings comprising high-dimensionality vectors comprising a first plurality of dimensions;
generating, based on inputting the high-dimensionality embeddings into a dimensionality reduction model that is configured to reduce the dimensionality of vectors of embeddings, a plurality of low-dimensionality embeddings comprising a plurality of low-dimensionality vectors, wherein each of the plurality of low-dimensionality vectors is based on the high-dimensionality vectors of the high-dimensionality embeddings and comprises a second plurality of dimensions that is smaller than the first plurality of dimensions of the high-dimensionality vectors; and
storing the plurality of low-dimensionality embeddings.

20. A computing system comprising:
one or more processors;
one or more non-transitory computer-readable media storing instructions that when executed by the one or more processors cause the one or more processors to perform operations comprising:
receiving high-dimensionality embeddings comprising high-dimensionality vectors comprising a first plurality of dimensions;
generating, based on inputting the high-dimensionality embeddings into a dimensionality reduction model that is configured to reduce the dimensionality of vectors of embeddings, a plurality of low-dimensionality embeddings comprising a plurality of low-dimensionality vectors, wherein each of the plurality of low-dimensionality vectors is based on the high-dimensionality vectors of the high-dimensionality embeddings and comprises a second plurality of dimensions that is smaller than the first plurality of dimensions of the high-dimensionality vectors; and
storing the plurality of low-dimensionality embeddings.
